(19) United States
(12) Patent Application Publication
(10) Pub. No.: US 2003/0225224 A1
(43) Pub. Date: Dec. 4, 2003

(54) Polymerization

(75) Inventors: Ioan Tincul, Sasolburg (ZA); Dawid Johannes Joubert, Sasolburg (ZA); Udo Maximilian Wahner, Sasolburg (ZA); Sarel Petrus Jacobus Smith, Meyersdal (ZA); Pieter Willem Van Zyl, Sasolburg (ZA)

Correspondence Address: Ladas & Parry, 26 West 61 Street, New York, NY, 10023, US

(73) Assignee: SASOL TECHNOLOGY (PROPRIETARY) LIMITED

(21) Appl. No.: 10/156,686

(22) Filed: May 28, 2002

(51) Int. Cl. C08F 2/00

(52) U.S. Cl. 526/65; 526/348.2; 526/348.3; 526/348.5; 526/901; 526/904; 526/124.3; 502/103

(57) ABSTRACT

A polymer includes at least propylene as a first monomeric component, 1-pentene as a second monomeric component, and, as a third monomeric component, a third olefin. The third olefin has fewer than 5 carbon atoms, is linear and is not propylene, or has 5 carbon atoms and is branched, or has more than 5 carbon atoms and is linear or branched.

THIS INVENTION relates to polymerization. It relates in particular to a polymer, and to a process for producing the polymer.

According to a first aspect of the invention, there is provided a polymer which includes at least propylene as a first monomeric component, 1-pentene as a second monomeric component, and, as a third monomeric component, a third olefin, wherein the third olefin has fewer than 5 carbon atoms, is linear and is not propylene, or has 5 carbon atoms and is branched, or has more than 5 carbon atoms and is linear or branched.

The polymer may, in particular, be a terpolymer.

The polymer of the invention is thus the reaction product of the first, second and third monomeric components. In other words, the polymer of the invention is that obtained by polymerisation of the first, second and third monomeric components.

When the third olefin has fewer than 5 carbon atoms, is linear and is not propylene, it may have a reactivity which is greater than that of 1-pentene. In particular, it may then be ethylene or 1-butene.

When the third olefin has 5 carbon atoms and is branched, it may be 3-methyl-1-butene.

When the third olefin has more than 5 carbon atoms and is linear, it may be 1-hexene, 1-heptene, 1-octene or 1-nonene.

When the third olefin has more than 5 carbon atoms and is branched, it may be 4-methyl-1-pentene or 3-methyl-1-pentene.

At least one of the monomeric components may be Fischer-Tropsch derived. By ‘Fischer-Tropsch derived’ in respect of a monomeric component is meant an olefinic monomeric component obtained by the so-called Fischer-Tropsch process, ie obtained by reacting a synthesis gas comprising carbon monoxide and hydrogen in the presence of a suitable Fischer-Tropsch catalyst, normally a cobalt, iron, or cobalt/iron Fischer-Tropsch catalyst, at elevated temperature in a suitable reactor, which is normally a fixed or slurry bed reactor, thereby to obtain a range of products, including monomers or components suitable for use in the polymers of this invention. The products from the Fischer-Tropsch reaction must then usually be worked up to obtain the individual products such as the monomers or components suitable for use in the polymers of the present invention.

In particular, the second monomeric component and/or the third monomeric component may be Fischer-Tropsch derived.

The inventors surprisingly discovered that when olefinic monomers employed in catalyzed polymerization as the second monomer or component, are obtained from the Fisher-Tropsch process, the resultant polymers have large domains of fundamental and/or application properties, and may be superior in some of these properties to those of polymers in which all the monomers have been obtained by conventional methods. The inventors believe that this unexpected behavior is due to small amounts of other olefinic components present in the Fischer Tropsch derived olefinic component and which until now have been regarded as impurities. These other olefinic components may be other hydrocarbons bearing one or more double bonds, whether linear, branched or aromatic, with the exception of those which poison or deactivate the catalyst to the extent that it no longer polymerizes the monomers. The inventors further believe that these components may sometimes function to change the polydispersity in the polymers obtained according to this invention, thus improving the processability of these polymers. These components may selectively and/or partially and/or temporarily modify the initiation of propylene polymerization or the insertion of the propylene in the growing chain or the termination of polymerization, thereby changing the distribution of the comonomers in the polymer chain and/or the content of the individual comonomers in the polymer and/or the molecular weight of the polymer and/or its molecular weight distribution, and/or its crystallizable sequence length and/or its morphology, with any one or more of these being reflected in unexpected application properties of the resultant polymers.

However, the inventors also discovered that, for practical applications when at least one of the comonomers employed in the polymerization as the second and third monomeric components is obtained from the Fisher-Tropsch process, the proportion of the other olefinic components referred to hereinbefore in at least one of the comonomers is preferably within particular limits.

Thus, the amount of these other olefinic components present in at least one of the comonomers, when obtained from the Fisher-Tropsch process may be from 0,002% to 2%, more preferably from 0,02% to 2%, and most preferably from 0,2% to 2%, based on the total mass of the comonomer, ie given on a mass or weight basis. However it is to be noted that in particular cases the total amount of the other olefinic components in the comonomer may be in excess of the limits hereinbefore set out.

The typical amounts and types of other olefinic impurities found in Fischer-Tropsch derived 1-pentene comprise mainly:

2-methyl-1-butene—0,46%

low proportion of branched olefins having a carbon number of 5

low proportion of internal olefins having a carbon number of 5

low proportion of cyclic olefins having a carbon number of 5

The typical amounts and types of other olefinic impurities found in Fischer-Tropsch derived 1-hexene comprise mainly:

branched olefins, mainly having a carbon number of 6—0,51%

internal olefins, mainly having a carbon number of 6—0,18%

cyclic olefins, mainly having a carbon number of 6—0,13%

The typical amounts and types of other olefinic impurities found in Fischer-Tropsch derived 1-heptene comprise mainly:

branched olefins, mainly having a carbon number of 7—0,48%

internal olefins, mainly having a carbon number of 7—0,53%

The typical amounts and types of other olefinic impurities found in Fischer-Tropsch derived 1-octene comprise mainly:

branched olefins, mainly having a carbon number of 8—0,41%

internal olefins, mainly having a carbon number of 8—0,83%

The typical amounts and types of other olefinic impurities found in Fischer-Tropsch 1-nonene comprise mainly:

branched olefins, mainly having a carbon number of 9—0,65%

internal olefins, mainly having a carbon number of 9—0,51%

Propylene and ethylene may also be those obtained from the Fischer-Tropsch process. However, due to the process of separation and purification involved in obtaining the Fischer-Tropsch derived ethylene or propylene, polymers containing these particular Fischer-Tropsch derived olefins may, in certain cases, not show any difference to polymers containing ethylene and propylene obtained from conventional processes, ie non-Fischer-Tropsch processes.

The Applicant has surprisingly ascertained that inside the broad or general family of terpolymers of propylene with 1-pentene and the third linear or branched olefin according to the first aspect of the invention, there are more particular families whose application properties differ unexpectedly. For example, it has been found that a terpolymer of propylene with 1-pentene and a further linear or branched olefin whose total number of carbon atoms is greater than 5 can have unexpected properties when compared with a terpolymer of propylene with 1-pentene and a further linear or branched olefin whose total number of carbon atoms is lower than 5. Still further, it has been found that a terpolymer of propylene with 1-pentene and a further linear or branched olefin which has a reaction rate higher than that of propylene can have even more unexpected properties when compared with a terpolymer of propylene with 1-pentene and a further linear or branched olefin whose reaction rate is lower than that of propylene.

When the further linear or branched olefin has fewer than 5 carbon atoms, it cannot be propylene since it has a reaction rate different to that of propylene.

The properties of this terpolymer are determined, firstly, by the ratio or proportion of propylene to the sum of 1-pentene and the third linear or branched olefin in the terpolymer, and, secondly, by the ratio or proportion of 1-pentene to the third linear or branched olefin. In other words, the properties of the terpolymer based on the propylene: sum of the total comonomer content, on a molar basis, differ according to the molar ratio of 1-pentene: third linear or branched olefin. In this manner, a large family of particular terpolymers having a large range of application properties controlled between certain limits, can be obtained. Typical applications of the terpolymer include extrusions, blow moulding, injection moulding, and thermoforming.

The properties of these terpolymers are also determined by the distribution of the comonomer units along the polypropylene backbone. The inventors found that this distribution of comonomer units is affected by the number of carbon atoms in the third monomer or component relative to those of the propylene and 1-pentene. In other words, this distribution of comonomer units is affected by the bulkiness of the third monomer or component relative to those of the propylene and 1-pentene.

The inventors surprisingly found that the reactivity of the third monomeric component relative to those of 1-pentene and propylene dictates the sequence composition, ie the type of monomer inserted following the last inserted monomer. In other words, the probability of a linear or branched olefin to be inserted depends on its carbon number. Thus, the higher its carbon number, the less likely the probability for the linear or branched olefin to be inserted into the growing polymer chain becomes.

In a first embodiment of the first aspect of the invention, the third olefin may be ethylene, which thus has fewer than 5 carbon atoms and a higher reaction rate than propylene. The polymer can then be a terpolymer of propylene with 1-pentene and ethylene.

In one version of the first embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and ethylene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

Ethylene is less bulky than 1-pentene and propylene and thus is incorporated into the polymer chain by a greater number of active sites than those capable of incorporating 1-pentene and propylene.

Thus, according to this version of the first embodiment of the invention the resulting terpolymer consists of a combination of polymer chains of ethylene alone, propylene together with ethylene, and chains containing ethylene, propylene and 1-pentene.

In a particular case of this version of the first embodiment of the invention, longer sequences or clusters of ethylene units than 1-pentene units are present in the polymer chain, ie a more heterogeneous distribution of the third monomeric component is present.

In another version of the first embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and ethylene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and ethylene may be between 99.9:0.1 and 50:50.

The ratio of the molar proportion of 1-pentene to that of ethylene may be between 0.01:99.99 and 99.99:0.01.

In a second embodiment of the first aspect of the invention, the third olefin may be 1-butene, which thus also has fewer than 5 carbon atoms and has a lower reaction rate than propylene. The polymer can then be a terpolymer of propylene with 1-pentene and 1-butene. It was surprisingly found that this family of polymers differ totally from the propylene/1-pentene/ethylene polymer family of the first embodiment of the first aspect of the invention.

In one version of the second embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 1-butene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

1-Butene is less bulky than 1-pentene and more bulky than propylene and thus is incorporated into the polymer chain by a greater number of active sites than those capable of incorporating 1-pentene and by a smaller number of active sites capable of incorporating propylene.

Thus according to this version of the second embodiment of the invention, the resulting terpolymer consists of a combination of polymer chains of propylene alone, propylene together with 1-butene and chains containing propylene, 1-butene and 1-pentene.

In a particular case of this version of the second embodiment of the invention, longer sequences or clusters of 1-butene units than 1-pentene units are present in the polymer chain, ie a more heterogeneous distribution of the third monomeric component is present.

In another version of the second embodiment of the invention, homogeneous metallocene catalysts or single-site catalysts where all active sites display similar properties may be used and for the production of the polymer, with a random distribution of comonomer units being obtained. In particular, the terpolymer may then be that obtained by reacting propylene, 1-pentene and 1-butene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 1-butene may be between 99.9:0.1 and 50:50.

The ratio of the molar proportion of 1-pentene to that of 1-butene may be between 0.01:99.99 and 99.99:0.01.

In a third embodiment of the first aspect of the invention, the third olefin has more than 5 carbon atoms, and is 1-hexene. It was surprisingly found that these polymers differ completely and fundamentally to polymers according to the first embodiment or those of the second embodiment of the first aspect of the invention.

In one version of the third embodiment of the invention, heterogeneous titanium chloride Ziegler-Natta catalysts may be used for the production of the polymer. In other words, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 1-hexene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

1-Hexene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the third embodiment of the invention, the resulting terpolymer consists of a combination of polymer chains of propylene alone, propylene together with 1-pentene and chains containing propylene, 1-pentene and 1-hexene.

In a particular case of this version of the third embodiment of the invention, shorter sequences or clusters of 1-hexene units than 1-pentene units are present in the polymer chain, ie a more random distribution of the third monomeric component is present.

In another version of the third embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 1-hexene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 1-hexene may be between 99.9:0.1 and 50:50.

The ratio of the molar proportion of 1-pentene to that of 1-hexene may be between 0.01:99.99 and 99.99:0.01.

A further particular case of the third embodiment is when 1-pentene and 1-hexene are extensively purified to similar purities as those of commercial polymerization grade 1-pentene and 1-hexene. These terpolymers are surprisingly different to terpolymers obtained using Fischer-Tropsch derived 1-pentene and 1-hexene which contain the further olefinic compounds at the levels hereinbefore described.

In a fourth embodiment of the first aspect of the invention, the third olefin has more than 5 carbon atoms, and is 1-heptene. It was surprisingly found that these polymers differ completely and fundamentally to polymers according to the first, second and third embodiments of the first aspect of the invention.

In one version of the fourth embodiment of the invention, heterogeneous titanium chloride Ziegler-Natta catalysts may be used for the production of the polymer. In other words, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 1-heptene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

1-Heptene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the fourth embodiment of the invention, the resulting terpolymer consists of a combination of polymer chains of propylene alone, propylene together with 1-pentene and chains containing propylene, 1-pentene and 1-heptene.

In a particular case of this version of the fourth embodiment of the invention, shorter sequences or clusters of 1-heptene units than 1-pentene units are present in the polymer chain, ie a more random distribution of the third monomeric component is present.

In another version of the fourth embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 1-heptene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 1-heptene may be between 99.9:0.1 and 50:50.

The ratio of the molar proportion of 1-pentene to that of 1-heptene may be between 0.01:99.99 and 99.99:0.01.

In a fifth embodiment of the first aspect of the invention, the third olefin has more than 5 carbon atoms, and is 1-octene. It was surprisingly found that these polymers differ completely and fundamentally to polymers according to the first, second, third and fourth embodiments of the first aspect of the invention.

In one version of the fifth embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 1-octene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

1-Octene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the fifth embodiment of the invention, the resulting terpolymer consists of a combination of polymer chains of propylene alone, propylene together with 1-pentene and chains containing propylene, 1-pentene and 1-octene.

In a particular case of this version of the fifth embodiment of the invention, shorter sequences or clusters of 1-octene units than 1-pentene units are present in the polymer chain, ie a more random distribution of the third monomeric component is present.

In another version of the fifth embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 1-octene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 1-octene may be between 99.9:0.1 and 50:50.

The ratio of the molar proportion of 1-pentene to that of 1-octene may be between 0.01:99.99 and 99.99:0.01.

In a sixth embodiment of the first aspect of the invention, the third olefin has more than 5 carbon atoms, and is 1-nonene. It was surprisingly found that these polymers differ completely and fundamentally to polymers according to the first, second, third fourth and fifth embodiments of the first aspect of the invention.

In one version of the sixth embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 1-nonene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

1-Nonene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the sixth embodiment of the invention, the resulting terpolymer consists of a combination of polymer chains of propylene alone, propylene together with 1-pentene and chains containing propylene, 1-pentene and 1-nonene.

In a particular case of this version of the sixth embodiment of the invention, shorter sequences or clusters of 1-nonene units than 1-pentene units are present in the polymer chain, ie a more random distribution of the third monomer or component is present.

In another version of the sixth embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 1-nonene in one or more reaction zones, while maintaining in the reaction zone(s) a pressure in the range between atmospheric pressure and 200 kg/cm² and a temperature between ambient and 120° C., in the presence of a suitable catalyst or catalyst system, particularly a metallocene catalyst or catalyst system.

The ratio of the molar proportion of propylene to that of the sum of the molar proportions of 1-pentene and 1-nonene may be between 99.9:0.1 and 50:50.

The ratio of the molar proportion of 1-pentene to that of 1-nonene may be between 0.01:99.99 and 99.99:0.01.

In a seventh embodiment of the first aspect of the invention, the third olefin has 5 carbon atoms, and is 3-methyl-1-butene. It was surprisingly found that these polymers differ completely and fundamentally to polymers according to the first, second, third, fourth, fifth and sixth embodiments of the first aspect of the invention.

In one version of the seventh embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 3-methyl-1-butene in one or more reaction zones, while maintaining in the reaction zone(s) a pressure in the range between atmospheric pressure and 200 kg/cm² and a temperature between ambient and 120° C., in the presence of a suitable catalyst or catalyst system, particularly a Ziegler-Natta catalyst or catalyst system.

3-Methyl-1-butene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the sixth embodiment of the invention, the resulting terpolymer consists of a combination of polymer chains of propylene alone, propylene together with 1-pentene and chains containing propylene, 1-pentene and 3-methyl-1-butene.

In a particular case of this version of the sixth embodiment of the invention, shorter sequences or clusters of 3-methyl-1-butene units than 1-pentene units are present in the polymer chain, ie a more random distribution of the third monomeric component is present.

In another version of the seventh embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 3-methyl-1-butene in one or more reaction zones, while maintaining in the reaction zone(s) a pressure in the range between atmospheric pressure and 200 kg/cm² and a temperature between ambient and 120° C., in the presence of a suitable catalyst or catalyst system, particularly a metallocene catalyst or catalyst system.

The ratio of the molar proportion of propylene to that of the sum of the molar proportions of 1-pentene and 3-methyl-1-butene may be between 99.9:0.1 and 50:50.

The ratio of the molar proportion of 1-pentene to that of 3-methyl-1-butene may be between 0.01:99.99 and 99.99:0.01.

In an eighth embodiment of the first aspect of the invention, the third olefin has more than 5 carbon atoms, and is 4-methyl-1-pentene. It was surprisingly found that these polymers differ completely and fundamentally to polymers according to the first, second, third fourth, fifth, sixth and seventh embodiments of the first aspect of the invention.

In one version of the eighth embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 4-methyl-1-pentene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

4-Methyl-1-pentene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the eighth embodiment of the invention, the resulting terpolymer consists of a combination of polymer chains of propylene alone, propylene together with 1-pentene and chains containing propylene, 1-pentene and 4-methyl-1-pentene.

In a particular case of this version of the sixth embodiment of the invention, shorter sequences or clusters of 4-methyl-1-pentene units than 1-pentene units are present in the polymer chain, ie a more random distribution of the third monomeric component is present.

In another version of the eighth embodiment of the invention, homogeneous metallocene catalysts or single-site catalysts where all active sites display similar properties may be used for the production of the polymer, with a random distribution of comonomer units being obtained. In particular, the terpolymer may then be that obtained by reacting propylene, 1-pentene and 4-methyl-1-pentene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 4-methyl-1-pentene may be between 99.9:0.1 and 50:50.

The ratio of the molar proportion of 1-pentene to that of 4-methyl-1-pentene may be between 0.01:99.99 and 99.99:0.01.

In a ninth embodiment of the first aspect of the invention, the third olefin has more than 5 carbon atoms, and is 3-methyl-1-pentene. It was surprisingly found that these polymers differ completely and fundamentally to polymers according to the first, second, third fourth, fifth, sixth, seventh and eighth embodiments of the first aspect of the invention.

In one version of the ninth embodiment of the invention, heterogeneous titanium chloride Ziegler-Natta catalysts may be used for the production of the polymer. In these catalysts, the active sites have different properties resulting from the presence and proximity of neighbouring atoms resulting in differing degrees of congestion around any given active site that dictate which carbon number olefin can react with it. In other words, highly congested active sites will react mostly with low carbon number olefins whereas weakly congested sites can react with low and higher carbon number olefins. In particular, the terpolymer may then be that obtained by reacting propylene, 1-pentene and 3-methyl-1-pentene in one or more reaction zones, while maintaining in the reaction zone(s) a pressure in the range between atmospheric pressure and 200 kg/cm² and a temperature between ambient and 120° C., in the presence of a Ziegler-Natta catalyst or catalyst system.

3-Methyl-1-pentene is more bulky than 1-pentene and more bulky than propylene and thus is incorporated into the polymer chain by a smaller number of active sites than those capable of incorporating 1-pentene and by a smaller number of active sites capable of incorporating propylene.

Thus according to this version of the ninth embodiment of the invention, the resulting terpolymer consists of a combination of polymer chains of propylene alone, propylene together with 1-pentene and chains containing propylene, 1-pentene and 3-methyl-1-pentene.

In a particular case of this version of the ninth embodiment of the invention, shorter sequences or clusters of 3-methyl-1-pentene units than 1-pentene units are present in the polymer chain, ie a more random distribution of the third monomeric component is present.

In another version of the ninth embodiment of the invention, homogeneous metallocene catalysts or single-site catalysts where all active sites display similar properties may be used for the production of the polymer, with a random distribution of comonomer units are obtained. In particular, the terpolymer may then be that obtained by reacting propylene, 1-pentene and 3-methyl-1-pentene in one or more reaction zones, while maintaining in the reaction zone(s) a pressure in the range between atmospheric pressure and 200 kg/cm² and a temperature between ambient and 120° C., in the presence of a metallocene catalyst or catalyst system.

The ratio of the molar proportion of propylene to that of the sum of the molar proportions of 1-pentene and 3-methyl-1-pentene may be between 99.9:0.1 and 50:50.

The ratio of the molar proportion of 1-pentene to that of 3-methyl-1-pentene may be between 0.01:99.99 and 99.99:0.01.

The polymer according to the first aspect of the invention for each embodiment hereinbefore described may have a melt flow rate as measured according to ASTM D 1238 in the range of 0.01 to about 100 g/10 min

The Applicant has also found that, in the terpolymerization of propylene with 1-pentene and a third olefin as hereinbefore described, even more particular terpolymers are obtained when different particular processes are employed to produce the terpolymers of propylene with 1-pentene and the third olefin.

Thus, according to a second aspect of the invention, there is provided a process for producing a polymer, which comprises reacting at least a first monomeric component comprising propylene, a second monomeric component comprising 1-pentene, and a third monomeric component comprising a third olefin which has fewer than 5 carbon atoms, is linear and is not propylene, or has 5 carbon atoms and is branched, or has more than 5 carbon atoms and is linear or branched, in one or more reaction zones, while maintaining the reaction zone(s) at a pressure between atmospheric pressure and 200 kg/cm², and at a temperature between ambient and 120° C., in the presence of a catalyst, or a catalyst system comprising a catalyst and a cocatalyst.

The reaction is thus carried out in one or more reaction zones, which may be provided in a single stage reactor vessel or by a chain of two or more reactor vessels.

The reaction may be effected in a batch fashion or in continuous fashion. Regardless of whether batch or continuous fashion is used, the manner in which the comonomer is introduced into the reaction zone(s) is of importance.

Thus, in one embodiment of this aspect of the invention, all three comonomers may be introduced continuously into the reaction zone(s) at constant flow and/or at constant pressure. Instead, however, the propylene can be introduced continuously or discontinuously while the other components are introduced either separately or simultaneously, and either continuously or discontinuously.

In another embodiment of this aspect of the invention, all three comonomers may be introduced intermittently in the same amounts or in different amounts at constant flow and/or constant pressure.

In yet another embodiment of this aspect of the invention, one or two of the comonomers may be introduced continuously into the reaction zone while the remaining comonomer(s) may be introduced intermittently in the same amount or different amounts at constant flow and/or constant pressure.

These different methods again provide a unique tool for obtaining a large variety of propylene, 1-pentene and further linear olefin terpolymers whose properties are mainly controlled by their composition and the manner of the comonomer incorporation. Each particular method differs from the other methods, and constitutes a novel method in the terpolymerization of propylene with 1-pentene and the third linear olefin.

In a first embodiment of the second aspect of the invention, the propylene, 1-pentene and the third olefin may be introduced into the reaction zone(s) in liquid phase. They may be introduced as separate components or as mixtures provided that the components rapidly evaporate in the reaction zone at the temperature and pressure employed.

To assist in the dispersion of reaction heat, a slurrying agent may be employed. The slurrying agent may be any saturated hydrocarbon which is a liquid at the temperatures and pressures employed. The slurrying agent is preferably a broad hexane, heptane or octane cut; however, it may also consist partially or completely of the monomers being polymerized.

Thus, according to a second embodiment of the second aspect of the invention, in the process of producing the polymer, the reactants, except for the catalyst components, may be dispersed in a hydrocarbon slurrying agent in the reaction zone(s) while the reaction is in progress.

Although slurry phase polymerization is very effective in assisting heat dispersion, propylene polymers become increasingly more soluble in the slurrying agents as the polymer comonomer content increases, which necessitates an additional separation and solvent purification step.

The inventors have discovered that by introducing the monomers into the reaction zone(s) in different fashion, the properties of the polymers can be changed and a large variety of polymers with different application properties can be obtained. According to this invention propylene polymers containing a semicrystalline phase and a less crystalline phase may be produced.

Thus, according to a third embodiment of the second aspect of the invention, propylene may be homopolymerized in a first reaction stage whereafter, in further or subsequent reaction stages, 1-pentene, or 1-pentene and the third olefin, or 1-pentene and the third olefin together with propylene, are added to the reaction zone(s). The ratio between the polymer produced in the first stage and the polymer produced in the subsequent stages may be between 1:99 to 99:1, preferably between 50:50 to 90:10. The ratio between 1-pentene and the third olefin may be between 0.01:99.99 and 99.99:0.01, while the overall total comonomer, ie 1-pentene and the third olefin combined, content may be between 0.5 and 90 wt %, preferably between 5 and 25 wt %.

In one version of the third embodiment of the second aspect of the invention, an amount of propylene may first be homopolymerized in the reaction zone(s) in the first stage, with a second step comprising reacting the balance of the propylene with 1-pentene, or with 1-pentene and the third olefin, by introducing the balance of the 1-pentene, or the balance of the 1-pentene, and the third olefin, at the beginning of the second and subsequent stages and by continuously introducing the propylene into the reaction zone under constant pressure.

In another version, an amount of propylene may first be homopolymerized in the reaction zone(s) in the first reaction stage, with a second step comprising reacting the balance of the propylene with 1-pentene, or with 1-pentene and the third olefin by introducing the balance of the 1-pentene, or the balance of the 1-pentene and the third olefin, at the beginning of the second and subsequent stages and by continuously introducing the propylene into the reaction zone under constant flow.

In yet another version, an amount of propylene may first be homopolymerized in the reaction zone(s) in the first reaction stage, with a second step comprising reacting the balance of the propylene with 1-pentene, or with 1-pentene and the third olefin by introducing the same amounts of the balance of the 1-pentene, or of the 1-pentene and the third olefin, intermittently during the second and subsequent stages and by continuously introducing the propylene into the reaction zone under constant flow or constant pressure.

In still another version, an amount of propylene may first be homopolymerized in the reaction zone(s) in the first reaction stage, with a second step comprising reacting the balance of the propylene with 1-pentene, or with 1-pentene and the third olefin, by introducing different amounts of the balance of the 1-pentene, or of the 1-pentene and the third olefin, intermittently during the second and subsequent stages and by continuously introducing the propylene into the reaction zone under constant flow or constant pressure.

In yet a further version, an amount of propylene may first be homopolymerized in the reaction zone(s) in the first reaction stage, with a second step comprising reacting the balance of the propylene with 1-pentene, or with 1-pentene and the third olefin, by introducing both the balance of the propylene and the 1-pentene, or of the 1-pentene and the third olefin, continuously into the second and subsequent stages at constant pressure or constant flow.

In order to improve the clarity of these blends, the 1-pentene or 1-pentene and the third olefin, may also be introduced during the first reaction stage.

Thus, according to a fourth embodiment of the second aspect of the invention, propylene may be copolymerized with 1-pentene, or with 1-pentene and the third olefin in the first reaction stage whereafter, during the second and subsequent stages, 1-pentene, or 1-pentene and the third olefin, or 1-pentene, the third olefin and propylene are added to the reaction zone(s). The ratio between the copolymer produced in the first stage and the copolymer produced in the subsequent stages is between 1:99 to 99:1, preferably between 50:50 to 90:10, while the overall 1-pentene, or 1-pentene and the third olefin, content of the blend is between 0.5 and 90 wt %, preferably between 5 and 25 wt %. The 1-pentene, or total 1-pentene and the third olefin content of the polymer produced during the first reaction stage is below 20 wt %, preferable below 10 wt %.

In one version of the fourth embodiment of the second aspect of the invention, an amount of propylene may first be copolymerized with 1-pentene, or with 1-pentene and the third olefin, in the reaction zone(s) in the first stage by introducing the separate monomers continuously or intermittently, followed by a second reaction stage comprising reacting the balance of the propylene with 1-pentene, or with 1-pentene and the third olefin, by introducing the separate monomers continuously or intermittently, each at its own flow rate or by reacting the balance of the 1-pentene, or of the 1-pentene and the third olefin, at the beginning of the second and subsequent stages and by continuously introducing the propylene into the reaction zone(s) under constant pressure.

In another version, an amount of propylene may first be copolymerized with 1-pentene, or with 1-pentene and the third olefin, in the reaction zone(s) in the first stage by introducing the separate monomers continuously or intermittently, with a second step comprising reacting the balance of the propylene with 1-pentene, or with 1-pentene and the third olefin, by introducing the balance of the 1-pentene, or of the 1-pentene and the third olefin, at the beginning of the second and subsequent stages and by continuously introducing the propylene into the reaction zone(s) under constant flow.

In yet another version, an amount of propylene may first be copolymerized with 1-pentene, or with 1-pentene and the third olefin, in the reaction zone(s) in the first stage by introducing the separate monomers continuously or intermittently, with a second step comprising reacting the balance of the propylene with 1-pentene, or with 1-pentene and the third linear or branched olefin, by introducing the same amounts of the balance of the 1-pentene, or of the 1-pentene and the third olefin, intermittently during the second and subsequent stages and by continuously introducing the propylene into the reaction zone(s) under constant flow or constant pressure.

In still another version, an amount of propylene may first be copolymerized with 1-pentene, or with 1-pentene and the third olefin, in the reaction zone(s) in the first stage by introducing the separate monomers continuously or intermittently, with a second step comprising reacting the balance of the propylene with 1-pentene, or with 1-pentene and the third olefin, by introducing different amounts of the balance of the 1-pentene, or of the 1-pentene and the third linear or branched olefin, intermittently during the second and subsequent stages and by continuously introducing the propylene into the reaction zone under constant flow or constant pressure.

In yet a further version, an amount of propylene may first be copolymerized with 1-pentene, or with 1-pentene and the third olefin, in the reaction zone(s) in the first stage by introducing the separate monomers continuously or intermittently, with a second step comprising reacting the balance of the propylene with 1-pentene, or with 1-pentene and the third olefin, by introducing both the balance of the propylene and the 1-pentene, or of the 1-pentene and the third olefin, continuously into the second and subsequent stages at constant pressure or constant flow.

These different methods again provide a unique tool for obtaining a large variety of propylene, 1-pentene and third olefin terpolymers whose properties are mainly controlled by their composition and the manner of the comonomer incorporation. Each particular method differs from the other methods, and constitutes a novel method in the terpolymerization of propylene with 1-pentene and the third olefin.

The molecular weight of the resultant random terpolymer can be regulated by hydrogen addition to the reaction zone(s) during the reaction. The greater the amount of hydrogen added, the lower will be the molecular weight of the random terpolymer. In addition, the molecular weight of the resultant random terpolymer can be regulated by changing the catalyst:aluminium ratio.

The terpolymerization is preferably performed in a substantially oxygen and water free state, and in the presence or absence of an inert saturated hydrocarbon.

The process according to the second aspect of the invention may thus be that by which the polymers according to the first aspect of the invention are obtained. Polymers of propylene, 1-pentene and the third olefin, when it has a carbon number lower than 5, may be obtained at a yield which is higher than that of polymers of propylene, 1-pentene and the third olefin, when it has a carbon number higher than 5, when a Ziegler-Natta catalyst or catalyst system is used.

The terpolymerization reaction according to this aspect of the invention may be carried out in slurry phase, solution phase or vapour phase, with slurry phase polymerization being preferred.

In one embodiment of this aspect of the invention, the third olefin may have a total number of carbon atoms greater than 5, as hereinbefore described.

In another embodiment of this aspect of the invention, the third olefin may have a total number of carbon atoms fewer than 5 and a reaction rate higher than that of propylene, as also hereinbefore described.

In yet another embodiment of this aspect of the invention, the third olefin may have a total number of carbon atoms fewer than 5 and a reaction rate lower than that of propylene, as hereinbefore described.

When slurry phase polymerization is used according to this aspect of the invention, the catalyst will be in solid form, and may comprise a Ziegler-Natta catalyst or catalyst system. Thus, the propylene, 1-pentene and the third olefin will be polymerized in a state of suspension in the slurrying or suspension agent, in the presence of the Ziegler-Natta catalyst or catalyst system in solid form and which is thus also suspended in the slurrying or suspension agent.

Any Ziegler-Natta catalyst or catalyst system which polymerizes propylene can, at least in principle, be used.

However, it was surprisingly found that a particular Ziegler-Natta catalyst gives the best performances. This most preferred catalyst is a novel catalyst obtained by a novel method of preparation as hereinafter described. Broadly, the novel catalyst is obtained by contacting an activated magnesium chloride support with titanium tetrachloride in the presence of an internal electron donor.

The magnesium chloride may be used in different forms, each of them leading to a different type of activated support.

Thus, in one particular manner of preparing the activated support, the magnesium chloride may be in form of anhydrous magnesium chloride.

In another particular manner of preparing the activated support, the magnesium chloride may be in form of magnesium chloride having a water content below 2 mole of water per 1 mole of magnesium chloride.

In yet another particular manner of preparing the activated support, the magnesium chloride may be in form of magnesium chloride having a water content between 2 and 6 mole of water per 1 mole of magnesium chloride.

The magnesium chloride is preferably activated prior to contacting or loading it with the titanium tetrachloride.

The activation of the magnesium chloride may be performed under inert conditions, ie in a substantially oxygen and water free atmosphere, and in the absence or in the presence of an inert saturated hydrocarbon liquid. Preferred inert saturated hydrocarbon liquids are aliphatic or cyclo-aliphatic liquid hydrocarbons, with the most preferred being hexane and heptane.

The magnesium chloride or support activation may be performed in two steps, (a₁) and (a₂) respectively.

For step (a₁), the inventors have discovered two particular different ways in which it can be performed and which result in different catalysts with different performances:

In one particular way, the magnesium chloride is treated with a mixture of more than one particular alcohol and an ether. The alcohols may be selected from the range of linear alcohols with the same number of carbon atoms as the monomers used in the subsequent terpolymerization effected with the catalyst. The preferred method is to use a mixture of three alcohols each with the same carbon number as one of the monomers used in the terpolymerization.

The ether may be selected from linear ethers having a total number of carbon atoms equal to twice the total number of carbon atoms of any of the monomers used in the terpolymerization. The most preferred ether is di-pentyl ether.

In another particular way, the magnesium chloride is treated with a mixture of more than one ether and a particular alcohol. The ethers may be selected from the range of linear ethers with a total number of carbon atoms equal to twice the total carbon number of the monomers used in the terpolymerization. The preferred method is to use a mixture of three ethers having, in total, twice the carbon number of the monomers used in the terpolymerization.

The alcohol may then be selected from linear alcohols having a total number of carbon atoms equal to the total number of carbon atoms of any one of the monomers used in the terpolymerization. The most preferred alcohol is pentanol.

The ether/alcohol mixture may be added under inert conditions to a suspension of the magnesium chloride in the inert hydrocarbon liquid or to the magnesium chloride in powder form.

The molar ratio of the ether/alcohol mixture to that of magnesium chloride may be from 1:1 to 6:1.

The resultant mixture may be stirred for a period of 10 minutes to 24 hours at room temperature. The preferred stirring time is 1 to 12 hours. A partially activated magnesium chloride is thus obtained.

In the second step (a₂), an alkyl aluminium compound may be added, preferably in dropwise fashion, to the partially activated magnesium chloride. Typical alkyl aluminium compounds which can be used are those expressed by the formula AlR₃ wherein R is an alkyl radical or radical component of 1 to 10 carbon atoms. Specific examples of suitable alkyl aluminium compounds which can be used are tri-butyl aluminium, tri-isobutyl aluminium, tri-hexyl aluminium and tri-octyl aluminium. However, preferred alkyl aluminium compounds are di-ethyl aluminium chloride and tri-ethyl aluminium. The molar ratio of the alkyl aluminium compound to the anhydrous magnesium chloride may be between 1:1 and 6:1.

The loading of the activated magnesium chloride support with the titanium tetrachloride may be performed in two steps, (b₁) and (b₂).

In the first step (b₁), to the support, after thorough washing thereof with hexane, is added an internal electron donor. The preferred internal electron donor is selected from the class of organic esters. The most preferred are organic esters of aromatic acids and alcohols selected from the range of alcohols with a total number of carbon atoms between two and 20. A particular case is that where the number of the carbon atoms of the alcohols used to prepare the electron donor ester is identical to the number of carbon atoms of the olefin, ie not the propylene and 1-pentene, employed in the subsequent terpolymerization according to this invention.

Examples of such electron donors are ethyl benzoate, propyl benzoate, butyl benzoate, pentyl benzoate, hexyl benzoate.

The weight ratio of the electron donor ester to the magnesium chloride used initially may be between 1:1 and 1:50.

In the second step (b₂), TiCl₄ may be added to the support/electron donor mixture, the mixture or slurry stirred under reflux and finally left to cool, e.g. for about 24 hours. The catalyst obtained may be thoroughly washed, eg with hexane.

More specifically, the Ziegler-Natta catalyst may be that obtained by

i) suspending partially anhydrous magnesium chloride containing between 2 and 6 moles of water in a highly purified hydrocarbon solvent to obtain a magnesium chloride slurry;

ii) adding to the slurry a mixture of alcohols and an ether with the alcohol:ether molar ratio being between 1:1 and 1:6, and stirring the mixture for a period of time between 10 minutes and 20 hours, to obtain a partially activated magnesium chloride;

iii) filtering and washing the partially activated magnesium chloride slurry with a highly purified hydrocarbon solvent until no ether is detected in the washing liquid, to obtain a washed partially activated magnesium chloride;

iv) adding thereto, in drop wise fashion, an alkyl aluminium compound with the molar ratio between the alkyl aluminum and the magnesium chloride between 1:1 and 1:6, followed by grinding to a smooth consistency and cooling to room temperature, to obtain an activated magnesium chloride;

v) washing the activated magnesium chloride with a highly purified hydrocarbon solvent until no alkyl aluminium is detected in the washing liquid, to obtain a washed activated magnesium chloride, which constitutes the support of the catalyst;

vi) adding an internal electron donor selected from the group of organic esters with the molar ratio between the ester and the magnesium chloride between 1:1 and 1:50;

vii) adding titanium tetrachloride to the resulting modified support, and grinding it to a smooth consistency to obtain a titanium loaded catalyst; and

viii) washing the titanium loaded catalyst with a highly purified hydrocarbon solvent until no titanium is detected in the washing liquid, to obtain the catalyst.

The molar ratio of TiCl₄ employed in this step to the magnesium chloride used initially may be from about 2:1 to about 20:1, preferably about 10:1.

The catalyst may be employed in the polymerization in the presence of an external electron donor and a cocatalyst.

Any external electron donor suitable for propylene polymerization can, at least in principle, be used. The most preferred external electron donors are selected from the class of organo-silanes. The most preferred external electron donors are dimethyl diethoxy silane, diethyl diethoxy silane, di-isopropyl dimethoxy silane, diphenyl dimethoxy silane, phenyl triethoxy silane, tetra-ethoxy silane.

The co-catalyst employed in the polymerization may be an organo-aluminium compound. Typical organo-aluminium compounds which can be used are compounds expressed by the formula AlRₘX₃₋ₘ wherein R is a hydrocarbon component of 1 to 1 5 carbon atoms, X is a halogen atom, and m is a number represented by 0<m<3. Specific examples of suitable organo aluminium compounds which can be used are a trialkyl aluminium, a trialkenyl aluminium, a partially halogenated alkyl aluminium, an alkyl aluminium sesquihalide, an alkyl aluminium dihalide. Preferred organo aluminium compounds are alkyl aluminium compounds, and the most preferred is tri-ethyl aluminium. The atomic ratio of aluminium to titanium in the catalyst system may be between 0.1:1 and 500:1, preferably between 1:1 and 100:1.

Preferred slurrying or suspension agents for the catalyst or catalyst system during the polymerization are aliphatic or cyclo-aliphatic liquid hydrocarbons, with the most preferred being hexane and heptane.

While the reaction temperature can be in the range of ambient to 120° C. during polymerization, it is preferably in the range of 50° C. to 100° C. and most preferably in the range of 60° C. to 90° C.

While the pressure can be in the range of atmospheric pressure to 200 kg/cm² during polymerization, it is preferably in the range of 3 kg/cm² to 30 kg/cm², still more preferably in the range of 4 kg/cm² to 18 kg/cm².

Instead, when slurry phase polymerization is used, the catalyst may comprise a metallocene or single site catalyst or catalyst system. Thus, the propylene, 1-pentene and the third olefin will then be polymerized in a state of suspension in the slurrying or suspension agent, in the presence of the metallocene or single site catalyst or catalyst system in solid form and which is thus also suspended in the slurrying or suspension agent.

Any metallocene or single site catalyst or catalyst system which polymerizes propylene can, at least in principle, be used. Examples of metallocenes which can be used are Group IV transition metallocenes (titanocenes, zirconocenes, hafnocenes), which are characterized by two bulky cyclopentadienyl (Cp) or substituted cyclopentadienyl ligands (Cp′) where the substituent may be linear or branched alkyl groups, substituted and un-substituted aromatic and cyclic aliphatic groups, metallocenes with two Cp′ ligands arranged in a chiral array and may be connected together with chemical bonds by a bridging group. The bridging group may be a linear, branched or aromatic or aliphatic carbon containing from 1 to 50 carbon atoms, germanium or silyl groups substituted with linear or branched alkyl groups, substituted and un-substituted aromatic and cyclic aliphatic groups. Table 1 shows a non-limiting list of metallocenes which can in principle be used.

TABLE 1
List of Metallocenes

| | |
|---|---|
| Cp₂ZrCl₂ | (Me₂Cp)₂ZrMe₂ |
| (n-BuCp)₂ZrCl₂ | (Me₅Cp)₂ZrMe₂ |
| (t-BuCp)₂ZrCl₂ | Cp₂ZrClMe |
| (i-BuCp)₂ZrCl₂ | (n-BuCp)₂ZrClMe |
| (n-Bu₂Cp)₂ZrCl₂ | (t-BuCp)₂ZrClMe |
| (t-Bu₂Cp)₂ZrCl₂ | (i-BuCp)₂ZrClMe |
| (i-Bu₂Cp)₂ZrCl₂ | (n-Bu₂Cp)₂ZrClMe |
| (n-Bu₅Cp)₂ZrCl₂ | (t-Bu₂Cp)₂ZrClMe |
| (t-Bu₅Cp)₂ZrCl₂ | (i-Bu₂Cp)₂ZrClMe |
| (i-Bu₅Cp)₂ZrCl₂ | (n-Bu₅Cp)₂ZrClMe |
| (n-PrCp)₂ZrCl₂ | (t-Bu₅Cp)₂ZrClMe |
| (t-PrCp)₂ZrCl₂ | (i-Bu₅Cp)₂ZrClMe |
| (i-PrCp)₂ZrCl₂ | (n-PrCp)₂ZrClMe |
| (n-Pr₂Cp)₂ZrCl₂ | (t-PrCp)₂ZrClMe |
| (t-Pr₂Cp)₂ZrCl₂ | (i-PrCp)₂ZrClMe |
| (i-Pr₂Cp)₂ZrCl₂ | (n-Pr₂Cp)₂ZrClMe |
| (n-Pr₅Cp)₂ZrCl₂ | (t-Pr₂Cp)₂ZrClMe |
| (t-Pr₅Cp)₂ZrCl₂ | (i-Pr₂Cp)₂ZrClMe |
| (i-Pr₅Cp)₂ZrCl₂ | (n-Pr₅Cp)₂ZrClMe |
| (PhCp)₂ZrCl₂ | (t-Pr₅Cp)₂ZrClMe |
| (Ph₂Cp)₂ZrCl₂ | (i-Pr₅Cp)₂ZrClMe |
| (MeCp)₂ZrCl₂ | (PhCp)₂ZrClMe |
| (Me₂Cp)₂ZrCl₂ | (Ph₂Cp)₂ZrClMe |
| (Me₅Cp)₂ZrCl₂ | (MeCp)₂ZrClMe |
| Cp₂ZrMe₂ | (Me₂Cp)₂ZrClMe |
| (n-BuCp)₂ZrMe₂ | (Me₅Cp)₂ZrClMe |
| (t-BuCp)₂ZrMe₂ | Cp₂TiCl₂ |
| (i-BuCp)₂ZrMe₂ | (n-BuCp)₂TiCl₂ |
| (n-Bu₂Cp)₂ZrMe₂ | (t-BuCp)₂TiCl₂ |
| (t-Bu₂Cp)₂ZrMe₂ | (i-BuCp)₂TiCl₂ |
| (i-Bu₂Cp)₂ZrMe₂ | (n-Bu₂Cp)₂TiCl₂ |
| (n-Bu₅Cp)₂ZrMe₂ | (t-Bu₂Cp)₂TiCl₂ |
| (t-Bu₅Cp)₂ZrMe₂ | (i-Bu₂Cp)₂TiCl₂ |
| (i-Bu₅Cp)₂ZrMe₂ | (n-Bu₅Cp)₂TiCl₂ |
| (n-PrCp)₂ZrMe₂ | (t-Bu₅Cp)₂TiCl₂ |
| (t-PrCp)₂ZrMe₂ | (i-Bu₅Cp)₂TiCl₂ |
| (i-PrCp)₂ZrMe₂ | (n-PrCp)₂TiCl₂ |
| (n-Pr₂Cp)₂ZrMe₂ | (t-PrCp)₂TiCl₂ |
| (t-Pr₂Cp)₂ZrMe₂ | (i-PrCp)₂TiCl₂ |
| (i-Pr₂Cp)₂ZrMe₂ | (n-Pr₂Cp)₂TiCl₂ |
| (n-Pr₅Cp)₂ZrMe₂ | (t-Pr₂Cp)₂TiCl₂ |
| (t-Pr₅Cp)₂ZrMe₂ | (i-Pr₂Cp)₂TiCl₂ |
| (i-Pr₅Cp)₂ZrMe₂ | (n-Pr₅Cp)₂TiCl₂ |
| (PhCp)₂ZrMe₂ | (t-Pr₅Cp)₂TiCl₂ |
| (Ph₂Cp)₂ZrMe₂ | (i-Pr₅Cp)₂TiCl₂ |
| (MeCp)₂ZrMe₂ | (PhCp)₂TiCl₂ |
| (Ph₂Cp)₂TiCl₂ | (t-Pr₅Cp)₂TiClMe |
| (MeCp)₂TiCl₂ | (i-Pr₅Cp)₂TiClMe |
| (Me₂Cp)₂TiCl₂ | (PhCp)₂TiClMe |
| (Me₅Cp)₂TiCl₂ | (Ph₂Cp)₂TiClMe |
| Cp₂TiMe₂ | (MeCp)₂TiClMe |
| (n-BuCp)₂TiMe₂ | (Me₂Cp)₂TiClMe |
| (t-BuCp)₂TiMe₂ | (Me₅Cp)₂TiClMe |
| (i-BuCp)₂TiMe₂ | Cp₂HfCl₂ |
| (n-Bu₂Cp)₂TiMe₂ | (n-BuCp)₂HfCl₂ |
| (t-Bu₂Cp)₂TiMe₂ | (t-BuCp)₂HfCl₂ |
| (i-Bu₂Cp)₂TiMe₂ | (i-BuCp)₂HfCl₂ |
| (n-Bu₅Cp)₂TiMe₂ | (n-Bu₂Cp)₂HfCl₂ |
| (t-Bu₅Cp)₂TiMe₂ | (t-Bu₂Cp)₂HfCl₂ |
| (i-Bu₅Cp)₂TiMe₂ | (i-Bu₂Cp)₂HfCl₂ |
| (n-PrCp)₂TiMe₂ | (n-Bu₅Cp)₂HfCl₂ |
| (t-PrCp)₂TiMe₂ | (t-Bu₅Cp)₂HfCl₂ |
| (i-PrCp)₂TiMe₂ | (i-Bu₅Cp)₂HfCl₂ |
| (n-Pr₂Cp)₂TiMe₂ | (n-PrCp)₂HfCl₂ |
| (t-Pr₂Cp)₂TiMe₂ | (t-PrCp)₂HfCl₂ |
| (i-Pr₂Cp)₂TiMe₂ | (i-PrCp)₂HfCl₂ |
| (n-Pr₅Cp)₂TiMe₂ | (n-Pr₂Cp)₂HfCl₂ |
| (t-Pr₅Cp)₂TiMe₂ | (t-Pr₂Cp)₂HfCl₂ |
| (i-Pr₅Cp)₂TiMe₂ | (i-Pr₂Cp)₂HfCl₂ |
| (PhCp)₂TiMe₂ | (n-Pr₅Cp)₂HfCl₂ |
| (Ph₂Cp)₂TiMe₂ | (t-Pr₅Cp)₂HfCl₂ |
| (MeCp)₂TiMe₂ | (i-Pr₅Cp)₂HfCl₂ |
| (Me₂Cp)₂TiMe₂ | (PhCp)₂HfCl₂ |
| (Me₅Cp)₂TiMe₂ | (Ph₂Cp)₂HfCl₂ |
| Cp₂TiClMe | (MeCp)₂HfCl₂ |
| (n-BuCp)₂TiClMe | (Me₂Cp)₂HfCl₂ |
| (t-BuCp)₂TiClMe | (Me₅Cp)₂HfCl₂ |
| (i-BuCp)₂TiClMe | Cp₂HfMe₂ |
| (n-Bu₂Cp)₂TiClMe | (n-BuCp)₂HfMe₂ |
| (t-Bu₂Cp)₂TiClMe | (t-BuCp)₂HfMe₂ |
| (i-Bu₂Cp)₂TiClMe | (i-BuCp)₂HfMe₂ |
| (n-Bu₅Cp)₂TiClMe | (n-Bu₂Cp)₂HfMe₂ |
| (t-Bu₅Cp)₂TiClMe | (t-Bu₂Cp)₂HfMe₂ |
| (i-Bu₅Cp)₂TiClMe | (i-Bu₂Cp)₂HfMe₂ |
| (n-PrCp)₂TiClMe | (n-Bu₅Cp)₂HfMe₂ |
| (t-PrCp)₂TiClMe | (t-Bu₅Cp)₂HfMe₂ |
| (i-PrCp)₂TiClMe | (i-Bu₅Cp)₂HfMe₂ |
| (n-Pr₂Cp)₂TiClMe | (n-PrCp)₂HfMe₂ |
| (t-Pr₂Cp)₂TiClMe | (t-PrCp)₂HfMe₂ |
| (i-Pr₂Cp)₂TiClMe | (i-PrCp)₂HfMe₂ |
| (n-Pr₅Cp)₂TiClMe | (n-Pr₂Cp)₂HfMe₂ |
| (t-Pr₂Cp)₂HfMe₂ | [O(SiMe₂Cp)₂]TiCl₂ |
| (i-Pr₂Cp)₂HfMe₂ | [O(SiMe₂ t-BuCp)₂]TiCl₂ |
| (n-Pr₅Cp)₂HfMe₂ | Ind₂HfCl₂ |
| (t-Pr₅Cp)₂HfMe₂ | (2-MeInd)₂HfCl₂ |
| (i-Pr₅Cp)₂HfMe₂ | (neomenthylCp)₂HfCl₂ |
| (PhCp)₂HfMe₂ | (C₅Me₄Et)₂HfCl₂ |
| (Ph₂Cp)₂HfMe₂ | [O(SiMe₂Cp)₂]HfCl₂ |
| (MeCp)₂HfMe₂ | [O(SiMe₂ t-BuCp)₂]HfCl₂ |
| (Me₂Cp)₂HfMe₂ | Ind₂ZrClMe |
| (Me₅Cp)₂HfMe₂ | (2-MeInd)₂ZrClMe |
| Cp₂HfClMe | (neomenthylCp)₂ZrClMe |
| (n-BuCp)₂HfClMe | (C₅Me₄Et)₂ZrClMe |
| (t-BuCp)₂HfClMe | [O(SiMe₂Cp)₂]ZrClMe |
| (i-BuCp)₂HfClMe | [O(SiMe₂ t-BuCp)₂]ZrClMe |
| (n-Bu₂Cp)₂HfClMe | Ind₂TiClMe |
| (t-Bu₂Cp)₂HfClMe | (2-MeInd)₂TiClMe |
| (i-Bu₂Cp)₂HfClMe | (neomenthylCp)₂TiClMe |
| (n-Bu₅Cp)₂HfClMe | (C₅Me₄Et)₂TiClMe |
| (t-Bu₅Cp)₂HfClMe | [O(SiMe₂Cp)₂]TiClMe |
| (i-Bu₅Cp)₂HfClMe | [O(SiMe₂ t-BuCp)₂]TiClMe |
| (n-PrCp)₂HfClMe | Ind₂HfClMe |
| (t-PrCp)₂HfClMe | (2-MeInd)₂HfClMe |
| (i-PrCp)₂HfClMe | (neomenthylCp)₂HfClMe |
| (n-Pr₂Cp)₂HfClMe | (C₅Me₄Et)₂HfClMe |
| (t-Pr₂Cp)₂HfClMe | [O(SiMe₂Cp)₂]HfClMe |
| (i-Pr₂Cp)₂HfClMe | [O(SiMe₂ t-BuCp)₂]HfClMe |
| (n-Pr₅Cp)₂HfClMe | Ind₂ZrMe₂ |
| (t-Pr₅Cp)₂HfClMe | (2-MeInd)₂ZrMe₂ |
| (i-Pr₅Cp)₂HfClMe | (neomenthylCp)₂ZrMe₂ |
| (PhCp)₂HfClMe | (C₅Me₄Et)₂ZrMe₂ |
| (Ph₂Cp)₂HfClMe | [O(SiMe₂Cp)₂]ZrMe₂ |
| (MeCp)₂HfClMe | [O(SiMe₂ t-BuCp)₂]ZrMe₂ |
| (Me₂Cp)₂HfClMe | Ind₂TiMe₂ |
| (Me₅Cp)₂HfClMe | (2-MeInd)₂TiMe₂ |
| Ind₂ZrCl₂ | (neomenthylCp)₂TiMe₂ |
| (2-MeInd)₂ZrCl₂ | (C₅Me₄Et)₂TiMe₂ |
| (neomenthylCp)₂ZrCl₂ | [O(SiMe₂Cp)₂]TiMe₂ |
| (C₅Me₄Et)₂ZrCl₂ | [O(SiMe₂ t-BuCp)₂]TiMe₂ |
| [O(SiMe₂Cp)₂]ZrCl₂ | Ind₂HfMe₂ |
| [O(SiMe₂ t-BuCp)₂]ZrCl₂ | (2-MeInd)₂HfMe₂ |
| Ind₂TiCl₂ | (neomenthylCp)₂HfMe₂ |
| (2-MeInd)₂TiCl₂ | (C₅Me₄Et)₂HfMe₂ |
| (neomenthylCp)₂TiCl₂ | [O(SiMe₂Cp)₂]HfMe₂ |
| (C₅Me₄Et)₂TiCl₂ | [O(SiMe₂ t-BuCp)₂]HfMe₂ |
| [En(Ind)₂]ZrCl₂ | [Me₂Si(IndFlu)]HfCl₂ |
| [En(Ind)₂]HfCl₂ | [Me₂Si(IndFlu)]TiCl₂ |
| [En(Ind)₂]TiCl₂ | [Me₂Si(IndFlu)]ZrMe₂ |
| [En(Ind)₂]ZrMe₂ | [Me₂Si(IndFlu)]HfMe₂ |
| [En(Ind)₂]HfMe₂ | [Me₂Si(IndFlu)]TiMe₂ |
| [En(Ind)₂]TiMe₂ | [Me₂Si(IndFlu)]ZrClMe |
| [En(Ind)₂]ZrClMe | [Me₂Si(IndFlu)]HfClMe |
| [En(Ind)₂]HfClMe | [Me₂Si(IndFlu)]TiClMe |
| [En(Ind)₂]TiClMe | [Bz₂Si(IndFlu)]ZrCl₂ |
| [Bimethyl | [Me₂Si(Ind)₂]ZrCl₂ |
| Naphtyl(Ind)₂]ZrCl₂ | [Me₂Si(Ind)₂]HfCl₂ |
| [Bimethyl | [Me₂Si(Ind)₂]TiCl₂ |
| Naphtyl(Ind)₂]HfCl₂ | [Me₂Si(Ind)₂]ZrMe₂ |
| [Bimethyl | [Me₂Si(Ind)₂]HfMe₂ |
| Naphtyl(Ind)₂]TiCl₂ | [Me₂Si(Ind)₂]TiMe₂ |
| [Bimethyl | [Me₂Si(Ind)₂]ZrClMe |
| Naphtyl(Ind)₂]ZrMe₂ | [Me₂Si(Ind)₂]HfClMe |
| [Bimethyl | [Me₂Si(Ind)₂]TiClMe |
| Naphtyl(Ind)₂]HfMe₂ | [Bz₂Si(Ind)₂]ZrCl₂ |
| [Bimethyl | [Bz₂Si(Ind)₂]HfCl₂ |
| Naphtyl(Ind)₂]TiMe₂ | [Bz₂Si(Ind)₂]TiCl₂ |
| [Bimethyl | [Bz₂Si(Ind)₂]ZrMe₂ |
| Naphtyl(Ind)₂]ZrClMe | [Bz₂Si(Ind)₂]HfMe₂ |
| [Bimethyl | [Bz₂Si(Ind)₂]TiMe₂ |
| Naphtyl(Ind)₂]HfClMe | [Bz₂Si(Ind)₂]ZrClMe |
| [Bimethyl | [Bz₂Si(Ind)₂]HfClMe |
| Naphtyl(Ind)₂]TiClMe | [Bz₂Si(Ind)₂]TiClMe |
| [Bz₂Si(BenzIndFlu)]TiCl₂ | [En(IndFlu)]ZrCl₂ |
| [Bz₂Si(BenzIndFlu)]ZrMe₂ | [En(IndFlu)]HfCl₂ |
| [Bz₂Si(BenzIndFlu)]HfMe₂ | [En(IndFlu)]TiCl₂ |
| [Bz₂Si(BenzIndFlu)]TiMe₂ | [En(IndFlu)]ZrMe₂ |
| [Bz₂Si(BenzIndFlu)]ZrClMe | [En(IndFlu)]HfMe₂ |
| [Bz₂Si(BenzIndFlu)]HfClMe | [En(IndFlu)]TiMe₂ |
| [Bz₂Si(BenzIndFlu)]TiClMe | [En(IndFlu)]ZrClMe |
| [Bimethyl | [En(IndFlu)]HfClMe |
| Naphtyl(BenzIndFlu)]ZrCl₂ | [En(IndFlu)]TiClMe |
| [Bimethyl | [Me₂Si(IndFlu)]ZrCl₂ |
| Naphtyl(BenzIndFlu)]HfCl₂ | [En(IndH₄)₂]HfMe₂ |
| [Bimethyl | [En(IndH₄)₂]TiMe₂ |
| Naphtyl(BenzIndFlu)]TiCl₂ | [En(IndH₄)₂]ZrClMe |
| [Bimethyl | [En(IndH₄)₂]HfClMe |
| Naphtyl(BenzIndFlu)]ZrMe₂ | [En(IndH₄)₂]TiClMe |
| [Bimethyl | [Bz₂Si(IndH₄)₂]ZrCl₂ |
| Naphtyl(BenzIndFlu)]HfMe₂ | [Bz₂Si(IndH₄)₂]HfCl₂ |
| [Bimethyl | [Bz₂Si(IndH₄)₂]TiCl₂ |
| Naphtyl(BenzIndFlu)]TiMe₂ | [Bz₂Si(IndH₄)₂]ZrMe₂ |
| [Bimethyl | [Bz₂Si(IndH₄)₂]HfMe₂ |
| Naphtyl(BenzIndFlu)]ZrClMe | [Bz₂Si(IndH₄)₂]TiMe₂ |
| [Bimethyl | [Bz₂Si(IndH₄)₂]ZrClMe |
| Naphtyl(BenzIndFlu)]HfClMe | [Bz₂Si(IndH₄)₂]HfClMe |
| [Bimethyl | [Bz₂Si(IndH₄)₂]TiClMe |
| Naphtyl(BenzIndFlu)]TiClMe | [Me₂Si(IndH₄)₂]ZrCl₂ |
| [En(IndCp)]ZrCl₂ | [Me₂Si(IndH₄)₂]HfCl₂ |
| [En(IndCp)]HfCl₂ | [Me₂Si(IndH₄)₂]TiCl₂ |
| [En(IndCp)]TiCl₂ | [Me₂Si(IndH₄)₂]ZrMe₂ |
| [En(IndCp)]ZrMe₂ | [Me₂Si(IndH₄)₂]HfMe₂ |
| [En(IndCp)]HfMe₂ | [Me₂Si(IndH₄)₂]TiMe₂ |
| [En(IndCp)]TiMe₂ | |
| [En(IndCp)]ZrClMe | [Bz₂Si(IndFlu)]HfCl₂ |
| [En(IndCp)]HfClMe | [Bz₂Si(IndFlu)]TiCl₂ |
| [En(IndCp)]TiClMe | [Bz₂Si(IndFlu)]ZrMe₂ |
| [Me₂Si(IndCp)]ZrCl₂ | [Bz₂Si(IndFlu)]HfMe₂ |
| [Me₂Si(IndCp)]HfCl₂ | [Bz₂Si(IndFlu)]TiMe₂ |
| [Me₂Si(IndCp)]TiCl₂ | [Bz₂Si(IndFlu)]ZrClMe |
| [Me₂Si(IndCp)]ZrMe₂ | [Bz₂Si(IndFlu)]HfClMe |
| [Me₂Si(IndCp)]HfMe₂ | [Bz₂Si(IndFlu)]TiClMe |
| [Me₂Si(IndCp)]TiMe₂ | [Bimethyl |
| [Me₂Si(IndCp)]ZrClMe | Naphtyl(IndFlu)]ZrCl₂ |
| [Me₂Si(IndCp)]HfClMe | [Bimethyl |
| [Me₂Si(IndCp)]TiClMe | Naphtyl(IndFlu)]HfCl₂ |
| [Bz₂Si(IndCp)]ZrCl₂ | [Bimethyl |
| [Bz₂Si(IndCp)]HfCl₂ | Naphtyl(IndFlu)]TiCl₂ |
| [Bz₂Si(IndCp)]TiCl₂ | [Bimethyl |
| [Bz₂Si(IndCp)]ZrMe₂ | Naphtyl(IndFlu)]ZrMe₂ |
| [Bz₂Si(IndCp)]HfMe₂ | [Bimethyl |
| [Bz₂Si(IndCp)TiMe₂ | Naphtyl(IndFlu)]HfMe₂ |
| [Bz₂Si(IndCp)]ZrClMe | [Bimethyl |
| [Bz₂Si(IndCp)]HfClMe | Naphtyl(IndFlu)]TiMe₂ |
| [Bz₂Si(IndCp)]TiClMe | [Bimethyl |
| [Bimethyl | Naphtyl(IndFlu)]ZrClMe |
| Naphtyl(IndCp)]ZrCl₂ | [Bimethyl |
| [Bimethyl | Naphtyl(IndFlu)]HfClMe |
| Naphtyl(IndCp)]HfCl₂ | [Bimethyl |
| [Bimethyl | Naphtyl(IndFlu)]TiClMe |
| Naphtyl(IndCp)]TiCl₂ | [En(BenzIndFlu)]ZrCl₂ |
| [Me₂Si(IndH₄)₂]ZrClMe | [En(BenzIndFlu)]HfCl₂ |
| [Me₂Si(IndH₄)₂]HfClMe | [En(BenzIndFlu)]TiCl₂ |
| [Me₂Si(IndH₄)₂]TiClMe | [En(BenzIndFlu)]ZrMe₂ |
| [Bimethyl | [En(BenzIndFlu)]HfMe₂ |
| Naphtyl(IndH₄)₂]ZrCl₂ | [En(BenzIndFlu)]TiMe₂ |
| [Bimethyl | [En(BenzIndFlu)]ZrClMe |
| Naphtyl(IndH₄)₂]HfCl₂ | [En(BenzIndFlu)]HfClMe |
| [Bimethyl | [En(BenzIndFlu)]TiClMe |
| Naphtyl(IndH₄)₂]TiCl₂ | [Me₂Si(BenzIndFlu)]ZrCl₂ |
| [Bimethyl | [Me₂Si(BenzIndFlu)]HfCl₂ |
| Naphtyl(IndH₄)₂]ZrMe₂ | [Me₂Si(BenzIndFlu)]TiCl₂ |
| [Bimethyl | [Me₂Si(BenzIndFlu)]ZrMe₂ |
| Naphtyl(IndH₄)₂]HfMe₂ | [Me₂Si(BenzIndFlu)]HfMe₂ |
| [Bimethyl | [Me₂Si(BenzIndFlu)]TiMe₂ |
| Naphtyl(IndH₄)₂]TiMe₂ | [Me₂Si(BenzIndFlu)]ZrClMe |
| [Bimethyl | [Me₂Si(BenzIndFlu)]HfClMe |
| Naphtyl(IndH₄)₂]ZrClMe | [Me₂Si(BenzIndFlu)]TiClMe |
| [Bimethyl | [Bz₂Si(BenzIndFlu)]ZrCl₂ |
| Naphtyl(IndH₄)₂]HfClMe | [Bz₂Si(BenzIndFlu)]HfCl₂ |
| [Bimethyl | [Bimethyl |
| Naphtyl(IndH₄)₂]TiClMe | Naphtyl(IndCp)]ZrMe₂ |
| [En(Flu)₂]ZrCl₂ | [Bimethyl |
| [En(Flu)₂]HfCl₂ | Naphtyl(IndCp)]HfMe₂ |
| [En(Flu)₂]TiCl₂ | [Bimethyl |
| [En(Flu)₂]ZrMe₂ | Naphtyl(IndCp)]TiMe₂ |
| [En(Flu)₂]HfMe₂ | [Bimethyl |
| [En(Flu)₂]TiMe₂ | Naphtyl(IndCp)]ZrClMe |
| [En(Flu)₂]ZrClMe | [Bimethyl |
| [En(Flu)₂]HfClMe | Naphtyl(IndCp)]HfClMe |
| [En(Flu)₂]TiClMe | [Bimethyl |
| [Me₂Si(Flu)₂]ZrCl₂ | Naphtyl(IndCp)]TiClMe |
| [Me₂Si(Flu)₂]HfCl₂ | [En(FluCp)]ZrCl₂ |
| [Me₂Si(Flu)₂]TiCl₂ | [En(FluCp)]HfCl₂ |
| [Me₂Si(Flu)₂]ZrMe₂ | [En(FluCp)]TiCl₂ |
| [Me₂Si(Flu)₂]HfMe₂ | [En(FluCp)]ZrMe₂ |
| Me₂Si(IndH₄)₂ZrCl₂ | [En(FluCp)]HfMe₂ |
| Me₂Si(2-MeInd)₂ZrCl₂ | [En(FluCp)]TiMe₂ |
| Me₂Si(2-Me-4-iPrInd)₂ZrCl₂ | [En(FluCp)]ZrClMe |
| Me₂Si(2,4-Me₂ Cp)₂ZrCl₂ | [En(FluCp)]HfClMe |
| Me₂Si(2-Me-4-tBuCp)₂ZrCl₂ | [En(FluCp)]TiClMe |
| Me₂Si(2-Me-4,5 BenzInd)₂ZrCl₂ | [Me₂Si(FluCp)]ZrCl₂ |
| Me₂Si(2-Me-4-PhInd)₂ZrCl₂ | [Me₂Si(FluCp)]HfCl₂ |
| Me₂Ge(2-Me-4-PhInd)₂ZrCl₂ | [Me₂Si(FluCp)]TiCl₂ |
| Me₂Si(2-Me-4-naphthInd)₂ZrCl₂ | [Me₂Si(FluCp)]ZrMe₂ |
| Bz₂Si(Ind)₂ZrCl₂ | [Me₂Si(FluCp)]HfMe₂ |
| Bz₂Si(IndH₄)₂ZrCl₂ | [Me₂Si(FluCp)]TiMe₂ |
| Bz₂Si(2-MeInd)₂ZrCl₂ | [Me₂Si(FluCp)]ZrClMe |
| Bz₂Si(2-Me-4-iPrInd)₂ZrCl₂ | [Me₂Si(FluCp)]HfClMe |
| Bz₂Si(2,4-Me₂ Cp)₂ZrCl₂ | [Me₂Si(FluCp)]TiClMe |
| Bz₂Si(2-Me-4-tBuCp)₂ZrCl₂ | [Bz₂Si(FluCp)]ZrCl₂ |
| Bz₂Si(2-Me-4,5 BenzInd)₂ZrCl₂ | [Bz₂Si(FluCp)]HfCl₂ |
| Bz₂Si(2-Me-4-PhInd)₂ZrCl₂ | [Bz₂Si(FluCp)]TiCl₂ |
| Bz₂Ge(2-Me-4-PhInd)₂ZrCl₂ | [Bz₂Si(FluCp)]ZrMe₂ |
| Bz₂Si(2-Me-4-naphthInd)₂ZrCl₂ | [Bz₂Si(FluCp)]HfMe₂ |
| Et(IndH₄)₂ZrCl₂ | [Bz₂Si(FluCp)]TiMe₂ |
| Et(2-MeInd)₂ZrCl₂ | [Bz₂Si(FluCp)]ZrClMe |
| Et(2-Me-4-iPrInd)₂ZrCl₂ | [Bz₂Si(FluCp)]HfClMe |
| Et(2,4-Me₂ Cp)₂ZrCl₂ | [Bz₂Si(FluCp)]TiClMe |
| Et(2-Me-4-tBuCp)₂ZrCl₂ | [Bimethyl |
| Et(2-Me-4,5 BenzInd)₂ZrCl₂ | Naphtyl(FluCp)]ZrCl₂ |
| Et(2-Me-4-PhInd)₂ZrCl₂ | [Bimethyl |
| Et(2-Me-4-PhInd)₂ZrCl₂ | Naphtyl(FluCp)]HfCl₂ |
| Et(2-Me-4-naphthInd)₂ZrCl₂ | [Bimethyl |
| Et(Ind)₂ZrCl₂ | Naphtyl(FluCp)]TiCl₂ |
| Et(IndH₄)₂ZrCl₂ | [Bimethyl |
| Et(2-MeInd)₂ZrCl₂ | Naphtyl(FluCp)]ZrMe₂ |
| Et(2-Me-4-iPrInd)₂ZrCl₂ | [Bimethyl |
| Et(2,4-Me₂ Cp)₂ZrCl₂ | Naphtyl(FluCp)]HfMe₂ |
| Et(2-Me-4-tBuCp)₂ZrCl₂ | [Bimethyl |
| Et(2-Me-4,5 BenzInd)₂ZrCl₂ | Naphtyl(FluCp)]TiMe₂ |
| Et(2-Me-4-PhInd)₂ZrCl₂ | [Bimethyl |
| Et(2-Me-4-PhInd)₂ZrCl₂ | Naphtyl(FluCp)]ZrClMe |
| Et(2-Me-4-naphthInd)₂ZrCl₂ | [Bimethyl |
| [En(2,4,7 Me₃Ind)₂TiCl₂ | Naphtyl(FluCp)]HfClMe |
| [En(IndH₄)₂]TiCl₂ | [Bimethyl |
| [Me₂Si (2,4,7 Me₃Ind)₂TiCl₂ | Naphtyl(FluCp)]TiClMe |
| [Me₂Si (IndH₄)₂]TiCl₂ | [En(IndH₄)₂]ZrCl₂ |
| [Me₂Si(Ind)₂]TiCl₂ | [En(IndH₄)₂]HfCl₂ |
| [Ph₂Si(Ind)₂]TiCl₂ | [En(IndH₄)₂]TiCl₂ |
| [Bz₂Si(Ind)₂]TiCl₂ | [En(IndH₄)₂]ZrMe₂ |
| [Me₂Si(2,4,7 Me-3-Ind)₂TiCl₂ | [Me₂Si(Flu)₂]TiMe₂ |
| [Me₂Si(IndH₄)₂]TiCl₂ | [Me₂Si(Flu)₂]ZrClMe |
| Et (2-MeInd)₂TiCl₂ | [Me₂Si(Flu)₂]HfClMe |
| Et(2-Me-4-iprInd)₂TiCl₂ | [Me₂Si(Flu)₂]TiClMe |
| Et(2,4-Me₂ Cp)₂TiCl₂ | [Bz₂Si(Flu)₂]ZrCl₂ |
| Et(2-Me-4-tBuCp)₂TiCl₂ | [Bz₂Si(Flu)₂]HfCl₂ |
| Et(2-Me-4,5 BenzInd)₂TiCl₂ | [Bz₂Si(Flu)₂]TiCl₂ |
| Et(2-Me-4-PhInd)₂TiCl₂ | [Bz₂Si(Flu)₂]ZrMe₂ |
| Et(2-Me-4-PhInd)₂TiCl₂ | [Bz₂Si(Flu)₂]HfMe₂ |
| Et(2-Me-4-naphthInd)₂TiCl₂ | [Bz₂Si(Flu)₂]TiMe₂ |
| [En(2,4,7 Me₃Ind)₂HfCl₂ | [Bz₂Si(Flu)₂ZrClMe |
| [En(IndH₄)₂]HfCl₂ | [Bz₂Si(Flu)₂]HfClMe |
| [Me₂Si (2,4,7 Me₃Ind)₂HfCl₂ | [Bz₂Si(Flu)₂]TiClMe |
| [Me₂Si (IndH₄)₂]HfCl₂ | [Bimethyl |
| [Me₂Si(Ind)₂]HfCl₂ | Naphtyl(Flu)₂]ZrCl₂ |
| [Ph₂Si(Ind)₂]HfCl₂ | [Bimethyl |
| [Bz₂Si(Ind)₂]HfCl₂ | Naphtyl(Flu)₂]HfCl₂ |
| [Me₂Si(2,4,7 Me-3-Ind)₂HfCl₂ | [Bimethyl |
| [Me₂Si(IndH₄)₂]HfCl₂ | Naphtyl(Flu)₂]TiCl₂ |
| [Me₂Si(2-Me-4,6-i- | [Bimethyl |
| PrInd)₂]HfCl₂ | Naphtyl(Flu)₂]ZrMe₂ |
| [Me₂Si(2Me 4PhInd)₂]HfCl₂ | [Bimethyl |
| [Me₂Si(2Me4,4BenzoInd)₂]HfCl₂ | Naphtyl(Flu)₂]HfMe₂ |
| [Me₂Si(2,4,7 Me-3-Ind)₂HfCl₂ | [Bimethyl |
| [Bz₂Si(IndH₄)₂]HfCl₂ | Naphtyl(Flu)₂]TiMe₂ |
| [Bz₂Si(2-Me-4,6-i- | [Bimethyl |
| PrInd)₂]HfCl₂ | Naphtyl(Flu)₂]ZrClMe |
| [Bz₂Si(2Me 4PhInd)₂]HfCl₂ | [Bimethyl |
| [Bz₂ | Naphtyl(Flu)₂]HfClMe |
| Si(2Me4,4BenzoInd)₂]HfCl₂ | [Bimethyl |
| [Ph₂C(Ind) (Cp)]HfCl₂ | Naphtyl(Flu)₂]TiClMe |
| [Me₂C(Ind) (Cp)]HfCl₂ | [En(2,4,7 Me₃Ind)₂ZrCl₂ |
| [Me₂C(Ind) (3-MeCp)]HfCl₂ | [En(IndH₄)₂]ZrCl₂ |
| [Ph₂C(Flu) (Cp)]HfCl₂ | [Me₂Si (2,4,7 Me₃Ind)₂ZrCl₂ |
| [Me₂C(Flu) (Cp)]HfCl₂ | [Me₂Si (IndH₄)₂]ZrCl₂ |
| [Me₂C(Flu) (Cp)]HfCl₂ | [Me₂Si(Ind)₂]ZrCl₂ |
| Et(Ind)₂HfCl₂ | [Ph₂Si(Ind)₂]ZrCl₂ |
| Me₂Si(Ind)₂HfCl₂ | [Bz₂Si(Ind)₂]ZrCl₂ |
| Me₂Si(IndH₄)₂HfCl₂ | [Me₂Si(2,4,7 Me-3-Ind)₂ZrCl₂ |
| Me₂Si(2-MeInd)₂HfCl₂ | [Me₂Si(IndH₄)₂]ZrCl₂ |
| Me₂Si(2-Me-4-iPrInd)₂HfCl₂ | [Me₂Si(2-Me-4,6-i- |
| Me₂Si(2,4-Me₂ Cp)₂HfCl₂ | PrInd)₂]ZrCl₂ |
| Me₂Si(2-Me-4-tBuCp)₂HfCl₂ | [Me₂Si(2Me 4PhInd)₂]ZrCl₂ |
| Me₂Si(2-Me-4,5 BenzInd)₂HfCl₂ | [Me₂Si(2Me4,4BenzoInd)₂]ZrCl₂ |
| Me₂Si(2-Me-4-PhInd)₂HfCl₂ | [Me₂Si(2,4,7 Me-3-Ind)₂ZrCl₂ |
| Me₂Ge(2-Me-4-PhInd)₂HfCl₂ | [Bz₂Si(IndH₄)₂]ZrCl₂ |
| Me₂Si(2-Me-4-naphthInd)₂HfCl₂ | [Bz₂Si(2-Me-4,6-i- |
| Bz₂Si(Ind)₂HfCl₂ | PrInd)₂]ZrCl₂ |
| Bz₂Si(IndH₄₎₂HfCl₂ | [Bz₂Si(2Me 4PhInd)₂]ZrCl₂ |
| Bz₂Si(2-MeInd)₂HfCl₂ | [Bz₂ |
| Bz₂Si(2-Me-4-iPrInd)₂HfCl₂ | Si(2Me4,4BenzoInd)₂]ZrCl₂ |
| Bz₂Si(2,4-Me₂ Cp)₂HfCl₂ | [Ph₂C(Ind) (Cp)]ZrCl₂ |
| Et(Ind)₂ZrMe₂ | [Me₂C(Ind) (Cp)]ZrCl₂ |
| Me₂Si(Ind)₂ZrMe₂ | [Me₂C(Ind) (3-MeCp)]ZrCl₂ |
| Me₂Si(IndH₄)₂ZrMe₂ | [Ph₂C(Flu) (Cp)]ZrCl₂ |
| Me₂Si(2-MeInd)₂ZrMe₂ | [Me₂C(Flu) (Cp)]ZrCl₂ |
| Me₂Si(2-Me-4-iPrInd)₂ZrMe₂ | [Me₂C(Flu) (Cp)]HfCl₂ |
| Me₂Si(2,4-Me₂ Cp)₂ZrMe₂ | Et(Ind)₂ZrCl₂ |
| Me₂Si(2-Me-4-tBuCP)₂ZrMe₂ | Me₂Si(Ind)₂ZrCl₂ |
| Me₂Si(2-Me-4,5 BenzInd)₂ZrMe₂ | [Me₂Si(2-Me-4,6-i- |
| Me₂Si(2-Me-4-PhInd)₂ZrMe₂ | PrInd)₂]TiCl₂ |
| Me₂Ge(2-Me-4-PhInd)₂ZrMe₂ | [Me₂Si(2Me 4PhInd)₂]TiCl₂ |
| Me₂Si(2-Me-4-naphthInd)₂ZrMe₂ | [Me₂Si(2Me4,4BenzoInd)₂]TiCl₂ |
| Bz₂Si(Ind)₂ZrMe₂ | [Me₂Si(2,4,7 Me-3-Ind)₂TiCl₂ |
| Bz₂Si(IndH₄)₂ZrMe₂ | [Bz₂Si(IndH₄)₂]TiCl₂ |
| Bz₂Si(2-MeInd)₂ZrMe₂ | [Bz₂Si(2-Me-4,6-i- |
| Bz₂Si(2-Me-4-iPrInd)₂ZrMe₂ | PrInd)₂]TiCl₂ |
| Bz₂Si(2,4-Me₂ Cp)₂ZrMe₂ | [Bz₂Si(2Me 4PhInd)₂]TiCl₂ |
| Bz₂Si(2-Me-4-tBuCp)₂ZrMe₂ | [Bz₂ |
| Bz₂Si(2-Me-4,5 BenzInd)₂ZrMe₂ | Si(2Me4,4BenzoInd)₂]TiCl₂ |
| Bz₂Si(2-Me-4-PhInd)₂ZrMe₂ | [Ph₂C(Ind) (Cp)]TiCl₂ |
| Bz₂Ge(2-Me-4-PhInd)₂ZrMe₂ | [Me₂C(Ind) (Cp)]TiCl₂ |
| Bz₂Si(2-Me-4-naphthInd)₂ZrMe₂ | [Me₂C(Ind) (3-MeCp)]TiCl₂ |
| Et(IndH₄)₂ZrMe₂ | [Ph₂C(Flu) (Cp)]TiCl₂ |
| Et(2-MeInd)₂ZrMe₂ | [Me₂C(Flu) (Cp)]TiCl₂ |
| Et(2-Me-4-iPrInd)₂ZrMe₂ | [Me₂C(Flu) (Cp)]HfCl₂ |
| Et(2,4-Me₂ Cp)₂ZrMe₂ | Et(Ind)₂TiCl₂ |
| Et(2-Me-4-tBuCp)₂ZrMe₂ | Me₂Si(Ind)₂TiCl₂ |
| Et(2-Me-4,5 BenzInd)₂ZrMe₂ | Me₂Si(IndH₄)₂TiCl₂ |
| Et(2-Me-4-PhInd)₂ZrMe₂ | Me₂Si(2-MeInd)₂TiCl₂ |
| Et(2-Me-4-PhInd)₂ZrMe₂ | Me₂Si(2-Me-4-iPrInd)₂TiCl₂ |
| Et(2-Me-4-naphthInd)₂ZrMe₂ | Me₂Si (2,4-Me₂ Cp)₂TiCl₂ |
| Et(Ind)₂ZrMe₂ | Me₂Si(2-Me-4-tBuCp)₂TiCl₂ |
| Et(IndH₄)₂ZrMe₂ | Me₂Si(2-Me-4,5 BenzInd)₂TiCl₂ |
| Et (2-MeInd)₂ZrMe₂ | Me₂Si(2-Me-4-PhInd)₂TiCl₂ |
| Et(2-Me-4-iPrInd)₂ZrMe₂ | Me₂Ge(2-Me-4-PhInd)₂TiCl₂ |
| Et(2,4-Me₂ Cp)₂ZrMe₂ | Me₂Si(2-Me-4-naphthInd)₂TiCl₂ |
| Et(2-Me-4-tBuCp)₂ZrMe₂ | Bz₂Si(Ind)₂TiCl₂ |
| Et(2-Me-4,5 BenzInd)₂ZrMe₂ | Bz₂Si(IndH₄)₂TiCl₂ |
| Et(2-Me-4-PhInd)₂ZrMe₂ | Bz₂Si(2-MeInd)₂TiCl₂ |
| Et(2-Me-4-PhInd)₂ZrMe₂ | Bz₂Si(2-Me-4-iprInd)₂TiCl₂ |
| Et(2-Me-4-naphthInd)₂ZrMe₂ | Bz₂Si (2,4-Me₂ Cp)₂TiCl₂ |
| [En(2,4,7 Me₃Ind)₂TiMe₂ | Bz₂Si(2-Me-4-tBuCp)₂TiCl₂ |
| [En(IndH₄)₂]TiMe₂ | Bz₂Si(2-Me-4,5 BenzInd)₂TiCl₂ |
| [Me₂Si (2,4,7 Me₃Ind)₂TiMe₂ | Bz₂Si(2-Me-4-PhInd)₂TiCl₂ |
| [Me₂Si (IndH₄)₂]TiMe₂ | Bz₂Ge(2-Me-4-PhInd)₂TiCl₂ |
| [Me₂Si(Ind)₂]TiMe₂ | Bz₂Si(2-Me-4-naphthInd)₂TiCl₂ |
| [Ph₂Si(Ihd)₂]TiMe₂ | Et(IndH₄)₂TiCl₂ |
| [Bz₂Si(Ind)₂]TiMe₂ | Et(2-MeInd)₂TiCl₂ |
| Et(Ind)₂TiMe₂ | Et(2-Me-4-iprInd)₂TiCl₂ |
| Et(IndH₄)₂TiMe₂ | Et(2,4-Me₂ Cp)₂TiCl₂ |
| Et (2-MeInd)₂TiMe₂ | Et(2-Me-4-tBuCp)₂TiCl₂ |
| Et(2-Me-4-iprInd)₂TiMe₂ | Et(2-Me-4,5 BenzInd)₂TiCl₂ |
| Et(2,4-Me₂ Cp)₂TiMe₂ | Et(2-Me-4-PhInd)₂TiCl₂ |
| Et(2-Me-4-tBuCp)₂TiMe₂ | Et(2-Me-4-PhInd)₂TiCl₂ |
| Et(2-Me-4,5 BenzInd)₂TiMe₂ | Et(2-Me-4-naphthInd)₂TiCl₂ |
| Et(2-Me-4-PhInd)₂TiMe₂ | Et(Ind)₂TiCl₂ |
| Et(2-Me-4-PhInd)₂TiMe₂ | Et(IndH₄)₂TiCl₂ |
| Et(2-Me-4-naphthInd)₂TiMe₂ | Bz₂Si(2-Me-4-tBuCp)₂HfCl₂ |
| [En(2,4,7 Me₃Ind)₂HfMe₂ | Bz₂Si(2-Me-4,5 BenzInd)₂HfCl₂ |
| [En(IndH₄)₂]HfMe₂ | Bz₂Si(2-Me-4-PhInd)₂HfCl₂ |
| [Me₂Si (2,4,7 Me3Ind)₂HfMe₂ | Bz₂Ge(2-Me-4-PhInd)₂HfCl₂ |
| [Me₂Si (IndH₄)₂]HfMe₂ | Bz₂Si(2-Me-4-naphthInd)₂HfCl₂ |
| [Me₂Si(Ind)₂]HfMe₂ | Et(IndH₄)₂HfCl₂ |
| [Ph₂Si(Ind)₂]HfMe₂ | Et(2-MeInd)₂HfCl₂ |
| [Bz₂Si(Ind)₂]HfMe₂ | Et(2-Me-4-iPrInd)₂HfCl₂ |
| [Me₂Si(2,4,7 Me-3-Ind)₂HfMe₂ | Et(2,4-Me₂ Cp)₂HfCl₂ |
| [Me₂Si(IndH₄)₂]HfMe₂ | Et(2-Me-4-tBuCp)₂HfCl₂ |
| [Me₂Si(2-Me-4,6-i- | Et(2-Me-4,5 BenzInd)₂HfCl₂ |
| PrInd)₂]HfMe₂ | Et(2-Me-4-PhInd)₂HfCl₂ |
| [Me₂Si(2Me 4PhInd)₂]HfMe₂ | Et(2-Me-4-PhInd)₂HfCl₂ |
| [Me₂Si(2Me4,4BenzoInd)₂]HfMe₂ | Et(2-Me-4-naphthInd)₂HfCl₂ |
| [Me₂Si(2,4,7 Me-3-Ind)₂HfMe₂ | Et(Ind)₂HfCl₂ |
| [Bz₂Si(IndH₄)₂]HfMe₂ | Et(IndH₄)₂HfCl₂ |
| [Bz₂Si(2-Me-4,6-i- | Et (2-MeInd)₂HfCl₂ |
| PrInd)₂]HfMe₂ | Et(2-Me-4-iPrInd)₂HfCl₂ |
| [Bz₂Si(2Me 4PhInd)₂]HfMe₂ | Et(2,4-Me₂ Cp)₂HfCl₂ |
| [Bz₂ | Et(2-Me-4-tBuCp)₂HfCl₂ |
| Si(2Me4,4BenzoInd)₂]HfMe₂ | Et(2-Me-4,5 BenzInd)₂HfCl₂ |
| [Ph₂C(Ind) (Cp)]HfMe₂ | Et(2-Me-4-PhInd)₂HfCl₂ |
| [Me₂C(Ind) (Cp)]HfMe₂ | Et(2-Me-4-PhInd)₂HfCl₂ |
| [Me₂C(Ind) (3-MeCp)]HfMe₂ | Et(2-Me-4-naphthInd)₂HfCl₂ |
| [Ph₂C(Flu) (Cp)]HfMe₂ | [En(2,4,7 Me₃Ind)₂ZrMe₂ |
| [Me₂C(Flu) (Cp)]HfMe₂ | [En(IndH₄)₂]ZrMe₂ |
| [Me₂C(Flu) (Cp)]HfMe₂ | [Me₂Si (2,4,7 Me₃Ind)₂ZrMe₂ |
| Et(Ind)₂HfMe₂ | [Me₂Si (IndH₄)₂]ZrMe₂ |
| Me₂Si(Ind)₂HfMe₂ | [Me₂Si(Ind)₂]ZrMe₂ |
| Me₂Si(IndH₄)₂HfMe₂ | [Ph₂Si(Ind)₂]ZrMe₂ |
| Me₂Si(2-MeInd)₂HfMe₂ | [Bz₂Si(Ind)₂]ZrMe₂ |
| Me₂Si(2-Me-4-iPrInd)₂HfMe₂ | [Me₂Si(2,4,7 Me-3-Ind)₂ZrMe₂ |
| Me₂Si (2,4-Me₂ Cp)₂HfMe₂ | [Me₂Si(IndH₄)₂]ZrMe₂ |
| Me₂Si(2-Me-4-tBuCp)₂HfMe₂ | [Me₂Si(2-Me-4,6-i- |
| Me₂Si(2-Me-4,5 BenzInd)₂HfMe₂ | PrInd)₂]ZrMe₂ |
| Me₂Si(2-Me-4-PhInd)₂HfMe₂ | [Me₂Si(2Me 4PhInd)₂]ZrMe₂ |
| Me₂Ge(2-Me-4-PhInd)₂HfMe₂ | [Me₂Si(2Me4,4BenzoInd)₂]ZrMe₂ |
| Me₂Si(2-Me-4-naphthInd)₂HfMe₂ | [Me₂Si(2,4,7 Me-3-Ind)₂ZrMe₂ |
| Bz₂Si(Ind)₂HfMe₂ | [Bz₂Si(IndH₄)₂]ZrMe₂ |
| Bz₂Si(IndH₄)₂HfMe₂ | [Bz₂Si(2-Me-4,6-i- |
| Bz₂Si(2-MeInd)₂HfMe₂ | PrInd)₂]ZrMe₂ |
| [Me₂C(Flu) (Cp)]ZrClMe | [Bz₂Si(2Me 4PhInd)₂]ZrMe₂ |
| [Me₂C(Flu) (Cp)]HfClMe | [Bz₂ |
| Et(Ind)₂ZrClMe | Si(2Me4,4BenzoInd)₂]ZrMe₂ |
| Me₂Si(Ind)₂ZrClMe | [Ph₂C(Ind) (Cp)]ZrMe₂ |
| Me₂Si(IndH₄)₂ZrClMe | [Me₂C(Ind) (Cp)]ZrMe₂ |
| Me₂Si(2-MeInd)₂ZrClMe | [Me₂C(Ind) (3-MeCp)]ZrMe₂ |
| Me₂Si(2-Me-4-iPrInd)₂ZrClMe | [Ph₂C(Flu) (Cp)]ZrMe₂ |
| Me₂Si(2,4-Me₂ Cp)₂ZrClMe | [Me₂C(Flu) (Cp)]ZrMe₂ |
| Me₂Si(2-Me-4-tBuCp)₂ZrClMe | [Me₂C(Flu) (Cp)]HfMe₂ |
| Me₂Si(2-Me-4,5 | [Me₂Si(2,4,7 Me-3-Ind)₂TiMe₂ |
| BenzInd)₂ZrClMe | [Me₂Si(IndH₄₎₂]TiMe₂ |
| Me₂Si(2-Me-4-PhInd)₂ZrClMe | [Me₂Si(2-Me-4,6-i- |
| Me₂Ge(2-Me-4-PhInd)₂ZrClMe | PrInd)₂]TiMe₂ |
| Me₂Si(2-Me-4- | [Me₂Si(2Me 4PhInd)₂]TiMe₂ |
| naphthInd)₂ZrClMe | [Me₂Si(2Me4,4BenzoInd)₂]TiMe₂ |
| Bz₂Si(Ind)₂ZrClMe | [Me₂Si(2,4,7 Me-3-Ind)₂TiMe₂ |
| Bz₂Si(IndH₄)₂ZrClMe | [Bz₂Si(IndH₄)₂]TiMe₂ |
| Bz₂Si(2-MeInd)₂ZrClMe | [Bz₂Si(2-Me-4,6-i- |
| Bz₂Si(2-Me-4-iprInd)₂ZrClMe | PrInd)₂]TiMe₂ |
| Bz₂Si (2,4-Me₂ Cp)₂ZrClMe | [Bz₂Si(2Me 4PhInd)₂]TiMe₂ |
| Bz₂Si(2-Me-4-tBuCp)₂ZrClMe | [Bz₂ |
| Bz₂Si(2-Me-4,5 | Si(2Me4,4BenzoInd)₂]TiMe₂ |
| BenzInd)₂ZrClMe | [Ph₂C(Ind) (Cp)]TiMe₂ |
| Bz₂Si(2-Me-4-PhInd)₂ZrClMe | [Me₂C(Ind) (Cp)]TiMe₂ |
| Bz₂Ge(2-Me-4-PhInd)₂ZrClMe | [Me₂C(Ind) (3-MeCp)]TiMe₂ |
| Bz₂Si(2-Me-4- | [Ph₂C(Flu) (Cp)]TiMe₂ |
| naphthInd)₂ZrClMe | [Me₂C(Flu) (Cp)]TiMe₂ |
| Et(IndH₄)₂ZrClMe | [Me₂C(Flu) (Cp)]HfMe₂ |
| Et(2-MeInd)₂ZrClMe | Et(Ind)₂TiMe₂ |
| Et(2-Me-4-iPrInd)₂ZrClMe | Me₂Si(Ind)₂TiMe₂ |
| Et(2,4-Me₂ Cp)₂ZrClMe | Me₂Si(IndH₄)₂TiMe₂ |
| Et(2-Me-4-tBuCp)₂ZrClMe | Me₂Si(2-MeInd)₂TiMe₂ |
| Et(2-Me-4,5 BenzInd)₂ZrClMe | Me₂Si(2-Me-4-iPrInd)₂TiMe₂ |
| Et(2-Me-4-PhInd)₂ZrClMe | Me₂Si (2,4-Me₂ Cp)₂TiMe₂ |
| Et(2-Me-4-PhInd)₂ZrClMe | Me₂Si(2-Me-4-tBuCp)₂TiMe₂ |
| Et(2-Me-4-naphthInd)₂ZrClMe | Me₂Si(2-Me-4,5 BenzInd)₂TiMe₂ |
| Et(Ind)₂ZrClMe | Me₂Si(2-Me-4-PhInd)₂TiMe₂ |
| Et(IndH₄)₂ZrClMe | Me₂Ge(2-Me-4-PhInd)₂TiMe₂ |
| Et(2-MeInd)₂ZrClMe | Me₂Si(2-Me-4-naphthInd)₂TiMe₂ |
| Et(2-Me-4-iPrInd)₂ZrClMe | Bz₂Si(Ind)₂TiMe₂ |
| Et(2,4-Me₂ Cp)₂ZrClMe | Bz₂Si(IndH₄)₂TiMe₂ |
| Et(2-Me-4-tBuCp)₂ZrClMe | Bz₂Si(2-MeInd)₂TiMe₂ |
| Et(2-Me-4,5 BenzInd)₂ZrClMe | Bz₂Si(2-Me-4-iprInd)₂TiMe₂ |
| Et(2-Me-4-PhInd)₂ZrClMe | Bz₂Si (2,4-Me₂ Cp)₂TiMe₂ |
| Et(2-Me-4-PhInd)₂ZrClMe | Bz₂Si(2-Me-4-tBuCp)₂TiMe₂ |
| Et(2-Me-4-naphthInd)₂ZrClMe | Bz₂Si(2-Me-4,5 BenzInd)₂TiMe₂ |
| [En(2,4,7 Me₃Ind)₂TiClMe | Bz₂Si(2-Me-4-PhInd)₂TiMe₂ |
| [En(IndH₄)₂]TiClMe | Bz₂Ge(2-Me-4-PhInd)₂TiMe₂ |
| [Me₂Si (2,4,7 Me₃Ind)₂TiClMe | Bz₂Si(2-Me-4-naphthInd)₂TiMe₂ |
| [Me₂Si (IndH₄)₂]TiClMe | Et(IndH₄)₂TiMe₂ |
| Et(2-Me-4-PhInd)₂TiClMe | Et(2-MeInd)₂TiMe₂ |
| Et(2-Me-4-PhInd)₂TiClMe | Et(2-Me-4-iPrInd)₂TiMe₂ |
| Et(2-Me-4-naphthInd)₂TiClMe | Et(2,4-Me₂ Cp)₂TiMe₂ |
| Et(Ind)₂TiClMe | Et(2-Me-4-tBuCp)₂TiMe₂ |
| Et(IndH₄)₂TiClMe | Et(2-Me-4,5 BenzInd)₂TiMe₂ |
| Et(2-MeInd)₂TiClMe | Et(2-Me-4-PhInd)₂TiMe₂ |
| Et(2-Me-4-iPrInd)₂TiClMe | Et(2-Me-4-PhInd)₂TiMe₂ |
| Et(2,4-Me₂ Cp)₂TiClMe | Et(2-Me-4-naphthInd)₂TiMe₂ |
| Et(2-Me-4-tBuCp)₂TiClMe | Bz₂Si(2-Me-4-iPrInd)₂HfMe₂ |
| Et(2-Me-4,5 BenzInd)₂TiClMe | Bz₂Si (2,4-Me₂ Cp)₂HfMe₂ |
| Et(2-Me-4-PhInd)₂TiClMe | Bz₂Si(2-Me-4-tBuCp)₂HfMe₂ |
| Et(2-Me-4-PhInd)₂TiClMe | Bz₂Si(2-Me-4,5 BenzInd)₂HfMe₂ |
| Et(2-Me-4-naphthInd)₂TiClMe | Bz₂Si(2-Me-4-PhInd)₂HfMe₂ |
| [En(2,4,7 Me₃Ind)₂HfClMe | Bz₂Ge(2-Me-4-PhInd)₂HfMe₂ |
| [En(IndH₄)₂]HfClMe | Bz₂Si(2-Me-4-naphthInd)₂HfMe₂ |
| [Me₂Si (2,4,7 Me₃Ind)₂HfClMe | Et(IndH₄)₂HfMe₂ |
| [Me₂Si (IndH₄)₂]HfClMe | Et(2-MeInd)₂HfMe₂ |
| [Me₂Si(Ind)₂]HfClMe | Et(2-Me-4-iPrInd)₂HfMe₂ |
| [Ph₂Si(Ind)₂]HfClMe | Et(2,4-Me₂ Cp)₂HfMe₂ |
| [Bz₂Si(Ind)₂]HfClMe | Et(2-Me-4-tBuCp)₂HfMe₂ |
| [Me₂Si(2,4,7 Me-3- | Et(2-Me-4,5 BenzInd)₂HfMe₂ |
| Ind)₂HfClMe | Et(2-Me-4-PhInd)₂HfMe₂ |
| [Me₂Si(IndH₄)₂]HfClMe | Et(2-Me-4-PhInd)₂HfMe₂ |
| [Me₂Si(2-Me-4,6-i- | Et(2-Me-4-naphthInd)₂HfMe₂ |
| PrInd)₂]HfClMe | Et(Ind)₂HfMe₂ |
| [Me₂Si (2Me 4PhInd)₂]HfClMe | Et(IndH₄)₂HfMe₂ |
| [Me₂Si(2Me4,4BenzoInd)₂]HfCl | Et(2-MeInd)₂HfMe₂ |
| Me | Et(2-Me-4-iPrInd)₂HfMe₂ |
| [Me₂Si(2,4,7 Me-3- | Et(2,4-Me₂ Cp)₂HfMe₂ |
| Ind)₂HfClMe | Et(2-Me-4-tBuCp)₂HfMe₂ |
| [Bz₂Si(IndH₄)₂]HfClMe | Et(2-Me-4,5 BenzInd)₂HfMe₂ |
| [Bz₂Si(2-Me-4,6-i- | Et(2-Me-4-PhInd)₂HfMe₂ |
| PrInd)₂]HfClMe | Et(2-Me-4-PhInd)₂HfMe₂ |
| [Bz₂Si(2Me 4PhInd)₂]HfClMe | Et(2-Me-4-naphthInd)₂HfMe₂ |
| [Bz₂ | [En(2,4,7 Me3Ind)₂ZrClMe |
| Si(2Me4,4BenzoInd)₂]HfClMe | [En(IndH₄)₂]ZrClMe |
| [Ph₂C(Ind) (Cp)]HfClMe | [Me₂Si (2,4,7 Me₃Ind)₂ZrClMe |
| [Me₂C(Ind) (Cp)]HfClMe | [Me₂Si (IndH₄)₂]ZrClMe |
| [Me₂C(Ind) (3-MeCp)]HfClMe | [Me₂Si(Ind)₂]ZrClMe |
| [Ph₂C(Flu) (Cp)]HfClMe | [Ph₂Si(Ind)₂]ZrClMe |
| [Me₂C(Flu) (Cp)]HfClMe | [Bz₂Si(Ind)₂]ZrClMe |
| [Me₂C(Flu) (Cp)]HfClMe | [Me₂Si(2,4,7 Me-3- |
| Et(2-Me-4-naphthInd)₂HfClMe | Ind)₂ZrClMe |
| Et(Ind)₂HfClMe | [Me₂Si(IndH₄)₂]ZrClMe |
| Me₂Si(Ind)₂HfClMe | [Me₂S-(2-Me-4,6-i- |
| Me₂Si(IndH₄)₂HfClMe | PrInd)₂]ZrClMe |
| Me₂Si(2-MeInd)₂HfClMe | [Me₂Si(2Me 4PhInd)₂]ZrClMe |
| Me₂Si(2-Me-4-iprInd)₂HfClMe | [Me₂Si(2Me4,4BenzoInd)₂]SrCl |
| Me₂Si(2,4-Me₂ Cp)₂HfClMe | Me |
| Me₂Si(2-Me-4-tBuCp)₂HfClMe | [Me₂Si(2,4,7 Me-3- |
| Me₂Ge(2-Me-4-PhInd)₂HfClMe | Ind)₂ZrClMe |
| Me₂Si(2-Me-4,5- | [Bz₂Si(IndH₄)₂]ZrClMe |
| BenzInd)₂HfClMe | [Bz₂Si(2-Me-4,6-i- |
| Et(2-Me-4,5 BenzInd)₂HfClMe | PrInd)₂]ZrClMe |
| Et(2-Me-4-PhInd)₂HfClMe | [Bz₂Si(2Me 4PhInd)₂]ZrClMe |
| Et(2-Me-4-PhInd)₂HfClMe | [Bz₂ |
| Et(2-Me-4-naphthInd)₂HfClMe | Si(2Me4,4BenzoInd)₂]ZrClMe |
| Et(Ind)₂HfClMe | [Ph₂C(Ind) (Op)]ZrClMe |
| Et(IndH₄)₂HfClMe | [Me₂C(Ind) (Cp)]ZrClMe |
| Et (2-MeInd)₂HfClMe | [Me₂C(Ind) (3-MeCp)]ZrClMe |
| Et(2-Me-4-iPrInd)₂HfClMe | [Ph₂C(Flu) (Cp)]ZrClMe |
| Et(2,4-Me₂ Cp)₂HfClMe | [Me₂Si(Ind)₂]TiClMe |
| Et(2-Me-4-tBuCp)₂HfClMe | [Ph₂Si(Ind)₂]TiClMe |
| Et(2-Me-4,5 BenzInd)₂HfClMe | [Bz₂Si(Ind)₂]TiClMe |
| Et(2-Me-4-PhInd)₂HfClMe | [Me₂Si(2,4,7 Me-3- |
| Et(2-Me-4-PhInd)₂HfClMe | Ind)₂TiClMe |
| Me₂Si(2-Me-4-PhInd)₂HfClMe | [Me₂Si(IndH₄)₂]TiClMe |
| Bz₂Si(2-Me-4,5 | [Me₂Si(2-Me-4,6-i- |
| BenzInd)₂HfClMe | PrInd)₂]TiClMe |
| Bz₂Si(2-Me-4-PhInd)₂HfClMe | [Me₂Si(2Me 4PhInd)₂]TiClMe |
| Bz₂Ge(2-Me-4-PhInd)₂HfClMe | [Me₂Si(2Me4,4BenzoInd)₂]TiCl |
| Bz₂Si(2-Me-4- | Me |
| naphthInd)₂HfClMe | [Me₂Si(2,4,7 Me-3- |
| Et(IndH₄)₂HfClMe | Ind)₂TiClMe |
| Et(2-MeInd)₂HfClMe | [Bz₂Si(IndH₄)₂]TiClMe |
| Et(2-Me-4-iPrInd)₂HfClMe | [Bz₂Si(2-Me-4,6-i- |
| Et(2,4-Me₂ Cp)₂HfClMe | PrInd)₂]TiClMe |
| Et(2-Me-4-tBuCp)₂HfClMe | [Bz₂Si(2Me 4PhInd)₂]TiClMe |
| Et(IndH₄)₂TiClMe | [Bz₂ |
| Et(2-MeInd)₂TiClMe | Si(2Me4,4BenzoInd)₂]TiClMe |
| Et(2-Me-4-iPrInd)₂TiClMe | [Ph₂C(Ind) (Cp)]TiClMe |
| Et(2,4-Me₂ Cp)₂TiClMe | [Me₂C(Ind) (Cp)]TiClMe |
| Et(2-Me-4-tBuCp)₂TiClMe | [Me₂C(Ind) (3-MeCp)]TiClMe |
| Et(2-Me-4,5 BenzInd)₂TiClMe | [Ph₂C(Flu) (Cp)]TiClMe |
| Me₂Si(2-Me-4- | [Me₂C(Flu) (Cp)]TiClMe |
| naphthInd)₂HfClMe | [Me₂C(Flu) (Cp)]HfClMe |
| Bz₂Si(Ind)₂HfClMe | Et(Ind)₂TiClMe |
| Bz₂Si(IndH₄)₂HfClMe | Me₂Si(Ind)₂TiClMe |
| Bz₂Si(2-MeInd)₂HfClMe | Me₂Si(IndH₄)₂TiClMe |
| Bz₂Si(2-Me-4-iPrInd)₂HfClMe | Me₂Si(2-MeInd)₂TiClMe |
| Bz₂Si (2,4-Me₂ Cp)₂HfClMe | Me₂Si(2-Me-4-iPrInd)₂TiClMe |
| Bz₂Si(2-Me-4-tBuCp)₂HfClMe | Me₂Si (2,4-Me₂ Cp)₂TiClMe |
| Bz₂Si (2,4-Me₂ Cp)₂TiClMe | Me₂Si(2-Me-4-tBuCp)₂TiClMe |
| Bz₂Si(2-Me-4-tBuCp)₂TiClMe | Me₂Si(2-Me-4,5 |
| Bz₂Si(2-Me-4,5 | BenzInd)₂TiClMe |
| BenzInd)₂TiClMe | Me₂Si(2-Me-4-PhInd)₂TiClMe |
| Bz₂Si(2-Me-4-PhInd)₂TiClMe | Me₂Ge(2-Me-4-PhInd)₂TiClMe |
| Bz₂Ge(2-Me-4-PhInd)₂TiClMe | Me₂Si(2-Me-4- |
| Bz₂Si(2-Me-4- | naphthInd)₂TiClMe |
| naphthInd)₂TiClMe | Bz₂Si(Ind)₂TiClMe |
| Bz₂Si(2-Me-4-iPrInd)₂TiClMe | Bz₂Si(IndH₄)₂TiClMe |
| | Bz₂Si(2-MeInd)₂TiClMe |

Preferred metallocene catalysts for propylene polymerization are ZL(AR)₂MX₂ catalysts, where Z is H, Me (methyl), Et (ethyl), Pr (propyl), i-Pr, Bu (butyl), i-Bu, or benzyl; L is a Z-substituted bridging group which 5 can be Si, Ge, or Et (ethyl); A is cyclopentadienyl, indenyl, or fluorenyl; R is H, Me (methyl), Et (ethyl), Pr (propyl), i-Pr, Bu (butyl), i-Bu, or benzyl; M is titanium, zirconium or hafnium; and X is Cl or CH₃.

The metallocene catalyst can be used as part of a catalyst system containing also a co-catalyst which activates the metallocene in the polymerization. Examples of such co-catalysts are alumoxanes such as methyl alumoxane (MAO), ethyl alumoxane (EAO), and isobutylalumoxane. The atomic ratio of aluminium to metal (M) in the catalyst system may be between 0,1:1 and 50000:1, preferably between 1:1 and 10000:1.

Different known methods of adding the cocatalyst can be used:

mixing the metallocene catalyst with the cocatalyst under inert conditions in an inert solvent and bringing the activated complex catalyst formed into the reaction zone prior or continuously during the terpolymerization; or

mixing the cocatalyst with solvent provided for the polymerization and introducing further the catalyst to form the catalyst complex prior to the terpolymerization; or

continuously supplying the catalyst and the cocatalyst to the reaction zone during the terpolymerization with the formation of the activated complex during the copolymerisation; or

any other method suitable for propylene polymerization can be used.

The molecular weight distribution of such terpolymers can vary according to a particular metallocene catalyst employed, a particular co-catalyst employed and a particular mixture of olefins employed.

Preferred slurrying or suspension agents for the catalyst or catalyst system during the polymerization are aliphatic or cyclo-aliphatic liquid hydrocarbons, with the most preferred being toluene and heptane.

While the reaction temperature can be in the range of −20 to 120° C. during polymerization, it is preferably in the range of 0° C. to 50° C. and most preferably in the range of 10° C. to 30° C.

While the pressure can be in the range of atmospheric pressure to 200 kg/cm² during polymerization, it is preferably in the range of 3 kg/cm² to 30 kg/cm², still more preferably in the range of 4 kg/cm² to 18 kg/cm².

When vapour phase polymerization is used, the catalyst may also be in solid form, and may comprise a Ziegler-Natta catalyst or catalyst system. Thus, the propylene, 1-pentene and the third olefin will be polymerized in the vapour phase in the presence of the Ziegler-Natta catalyst or catalyst system in solid form.

Any suitable Ziegler-Natta catalyst for propylene polymerization in vapour phase can, at least in principle, then be used. More particularly, a silica supported catalyst, a prepolymerized catalyst or a polymer diluted catalyst may be used. A catalyst system comprising a titanium based Ziegler Natta catalyst and, as co-catalyst, an organo aluminium compound, is preferred. Most preferred is a prepolymerized titanium catalyst and a polymer diluted titanium catalyst.

The catalyst may be that obtained by contacting activated anhydrous magnesium chloride with titanium tetrachloride in the presence of an internal electron donor as described hereinbefore. This catalyst may then be further prepolymerized or polymer diluted.

When a prepolymerization Ziegler-Natta catalyst is used, it may be one that has been prepolymerized in the presence of propylene, 1-pentene and a third olefin which has fewer than 5 carbon atoms, is linear and is not propylene, or has 5 carbon atoms and is branched, or has more than 5 carbon atoms and is linear or branched.

For the prepolymerization of the Ziegler-Natta catalyst, alpha-olefins of 2 to 8 carbon atoms are preferred as the third olefin. The amount of polymer resulting from the prepolymerization is preferred to be in the range of 1 to 500 g/g of catalyst. Two cases regarding the amount of prepolymer obtained after the prepolymerization can be distinguished:

(i) an amount of 2-5 g of prepolymer/g of catalyst

(ii) an amount of 6-500 g of prepolymer/g of catalyst

Instead, when vapour phase polymerization is used, the catalyst may also be in solid form, and may comprise a metallocene or single site catalyst or catalyst system. Thus, the propylene, 1-pentene and the third olefin will then be polymerized in the vapour phase in the presence of the metallocene or single site catalyst or catalyst system in solid form.

Any suitable metallocene or single site catalyst for propylene polymerization in vapour phase can, at least in principle, then be used. More particularly, a supported catalyst, a prepolymerized catalyst or a polymer diluted catalyst may be used. A catalyst system comprising a metallocene or single site catalyst and, as co-catalyst, an organo aluminium compound, is preferred. Most preferred is a prepolymerized metallocene or single site catalyst and a polymer diluted metallocene or single site catalyst.

When a prepolymerized metallocene catalyst is used, it may be one that has been prepolymerized in the presence of propylene, 1-pentene and a third olefin which has fewer than 5 carbon atoms, is linear and is not propylene, or has 5 carbon atoms and is branched, or has more than 5 carbon atoms and is linear or branched.

For the prepolymerization of the metallocene or single site catalyst, alpha-olefins of 2 to 9 carbon atoms are preferred as the third olefin. The amount of polymer resulting from the prepolymerization is preferred to be in the range of 10 to 5000 g/g of catalyst. Two cases regarding the amount of prepolymer obtained after the prepolymerization can be distinguished:

(i) an amount of 20-50 g of prepolymer/g of catalyst

(ii) an amount of 60-5000 g of prepolymer/g of catalyst

The inventors have surprisingly found that different terpolymers are obtained with vapour phase terpolymerization according to this invention if the prepolymer is obtained by terpolymerization of propylene with 1-pentene and a further linear or branched olefin which is the same linear or branched third olefin employed in the terpolymerization process.

The inventors have also surprisingly found that different terpolymers are obtained with vapour phase terpolymerization according to this invention if the prepolymer is obtained by terpolymerization as described above and the further linear or branched olefin is employed in this terpolymerization in different proportions in order to obtain prepolymers with different further linear or branched olefin content. The ratio of the molar proportion of propylene to that of the sum of the molar proportions of 1-pentene and the further linear or branched olefin may be between 99,9:0.1 and 50:50.

The ratio of the molar proportion of 1-pentene to that of the further linear or branched olefin may be between 0,01:99,99 and 99,99:0,01. The preferred further linear or branched olefin content in the mixture with 1-pentene is more than 10% by weight and more preferably more than 20% by weight, based on the total mixture weight. The most preferred prepolymers are those obtained when the prepolymer has the same further linear or branched olefin content as the final terpolymer obtained in the vapour phase terpolymerization according to this aspect of the invention.

In order to obtain the prepolymer, a cocatalyst may be used together with the particular catalyst as hereinbefore described.

When the catalyst is a Ziegler-Natta catalyst, the co-catalyst employed may be an organo aluminium compound.

Typical organo-aluminium compounds which can be used are compounds expressed by the formula AlRₘX₃₋ₘ wherein R is a hydrocarbon component of 1 to 15 carbon atoms, X is a halogen atom, and m is a number represented by 0<m<3. Specific examples of suitable organo aluminium compounds which can be used are a trialkyl aluminium, a trialkenyl aluminium, a partially halogenated alkyl aluminium, an alkyl aluminium sesquihalide, an alkyl aluminium dihalide. Preferred organo aluminium compounds are alkyl aluminium compounds, and the most preferred is tri-ethyl aluminium. The atomic ratio of aluminium to titanium in the catalyst system may be between 0,1:1 and 10000:1, preferably between 1:1 and 5000:1.

When the catalyst is a metallocene or single site catalyst, the co-catalyst employed may be an organo aluminium compound. Examples of such co-catalysts are alumoxanes such as methyl alumoxane (MAO), ethyl alumoxane (EAO), and isobutylalumoxane. The atomic ratio of aluminium to metal (M) in the catalyst system may be between 0,1:1 and 50000:1, preferably between 1:1 and 10000:1.

In one version, the prepolymer may be prepared in a separate stirred vessel in suspension in a slurrying agent and supplied to a gas phase reactor in slurry phase in order to terpolymerize the monomers according to this invention. In this case the reaction temperature in the gas phase terpolymerization unit may be above the temperature which will allow the small amount of catalyst carrier solvent to vaporize instantly at the pressure employed in the terpolymerization.

In another version, the prepolymer may be prepared in a separate stirred vessel in suspension in a slurrying agent and may be dried in a separate unit to remove the solvent from the catalyst slurry, with the dried catalyst being supplied to the gas phase reactor. In this case, the temperature of the drying unit may be below the temperature which deactivates the prepolymer, i.e. the temperature above which the catalyst loses more than 10% of its activity over a period of 24 hours. The catalyst is transferred to the reactor under an inert gas such as highly purified nitrogen.

Preferred slurrying or suspension agents are aliphatic or cyclo-aliphatic liquid hydrocarbons, with the most preferred being hexane and heptane, when a Ziegler-Natta catalyst is used, and toluene and heptane, when a metallocene or single site catalyst is used.

The temperature during the prepolymerization may between −15° C. and 80° C., provided that the temperature is kept constant during the prepolymerization. The pressure may be between atmospheric pressure and 10 kg/cm². According to this invention, nitrogen or an inert gas is desirably present in the reaction medium in order to control the low amount of prepolymer obtained during the prepolymerization. The preferred amount of nitrogen is between 10% and 90% of the reaction gas phase present in the prepolymerization unit.

In another embodiment of this aspect of the invention, a polymer diluted catalyst may be used. The polymer used may preferably be in powder form. The most preferred is a polymer in powder form and having the same granularity as the final terpolymer. In other words a powder polymer with the same level of average particle size and/or average particle size distribution as the final terpolymer, is preferred. The polymer diluted catalyst is obtained by mixing the catalyst in particulate form with the polymer in powder form.

Any polymer inactive to the catalyst may then be used. The preferred polymer is a propylene polymer, and the most preferred polymer is a terpolymer with the same monomer make-up and content as the terpolymer obtained in the gas phase process according to this invention, ie a terpolymer of propylene, 1-pentene and a third olefin which has fewer than 5 carbon atoms, is linear and is not propylene, or has 5 carbon atoms and is branched, or has more than 5 carbon atoms and is linear or branched.

Mixing of the catalyst may be performed by mechanical stirring of the catalyst with the polymer powder. Other known methods of stirring are also possible. The catalyst may be added to the polymer powder in a powder form or in a slurry form. The Applicant has found that the best results are obtained when the catalyst is added to a suspension of the powder catalyst in an inert liquid hydrocarbon, the resultant slurry mixed and the solvent evaporated to obtain a polymer diluted catalyst in powder form. In a particular case, the polymer diluted catalyst slurry may be supplied directly to the gas phase polymerization reactor provided that the temperature in the reactor allows immediate vaporisation of the limited amount of carrying solvent for the polymer diluted catalyst.

A cocatalyst may be added to the polymer powder support prior to the addition of the catalyst, or concomitantly therewith.

When a Ziegler-Natta catalyst is used, the co-catalyst employed may be an organo aluminium compound. Typical organo-aluminium compounds which can be used are compounds expressed by the formula AlRₘX₃₋ₘ wherein R is a hydrocarbon component of 1 to 15 carbon atoms, X is a halogen atom, and m is a number represented by 0<m<3. Specific examples of suitable organo aluminium compounds which can be used are a trialkyl aluminium, a trialkenyl aluminium, a partially halogenated alkyl aluminium, an alkyl aluminium sesquihalide, an alkyl aluminium dihalide. Preferred organo aluminium compounds are alkyl aluminium compounds, and the most preferred is tri-ethyl aluminium. The atomic ratio of aluminium to titanium in the catalyst system may be between 0,1:1 and 10000:1, preferably between 1:1 and 5000:1.

When a metallocene or single site catalyst is used, the co-catalyst employed may be an organo aluminium compound. Examples of such co-catalysts are alumoxanes such as methyl alumoxane (MAO), ethyl alumoxane (EAO), and isobutylalumoxane. The atomic ratio of aluminium to metal (M) in the catalyst system may be between 0,1:1 and 50000:1, preferably between 1:1 and 10000:1.

The mixing of the polymer powder with the catalyst as hereinbefore described in the presence or absence of the cocatalyst, may be performed preferably at a temperature between −10° C. and 40° C., when a Ziegler-Natta catalyst is used, and between −15° and 40° C., when a metallocene or single site catalyst is used, more preferably at ambient temperature.

The vapour phase reaction may be carried out in one or more stirred reaction zones, in a single stage reactor vessel or a chain of two or more reaction vessels, in a batch or continuous fashion, as described hereinbefore. The 1-pentene and further linear or branched olefin may be added as a mixture or separately in a pre-vaporized vapour phase or in liquid phase and vaporized in the reaction zone.

The preferred reactor for the terpolymerization according to this invention is a stirred reactor, ie a reactor in which the gas phase reaction medium and as well the mixture of the terpolymer obtained in powder form in the gas phase reaction medium are stirred by mechanical means known in the art.

The molecular weight of the resultant random terpolymer can be regulated by hydrogen addition to the reaction zone during the reaction. The greater the amount of hydrogen added, the lower will be the molecular weight of the random terpolymer.

The vapour phase terpolymerization process according to this invention contemplates bringing in contact in the reaction zone

propylene with, as comonomers, at least 1-pentene and the third olefin having a total number of carbon atoms greater than 5; or

propylene with, as comonomers, at least 1-pentene and the third olefin having a total number of carbon atoms lower than 5 and a reaction rate higher than that of propylene; or

propylene with, as comonomers, at least 1-pentene and the third olefin having a total number of carbon atoms lower than 5 and a reaction rate lower than that of propylene.

An inert gas may also be present in the polymerization zone. Examples of such inert gases according to this invention are highly purified nitrogen or argon, with nitrogen being the most preferred.

In one embodiment of this aspect of the invention, the presence of the nitrogen is not only possible but also desirable. In this case the nitrogen acts as a diluting agent for the gas polymerization medium and as such controls the activity of the catalyst during the gas phase terpolymerization.

According to a third aspect of the invention, there is provided a method of making a catalyst suitable for use in a process for producing polymers, which method comprises, broadly, contacting an activated magnesium chloride support with titanium tetrachloride in the presence of an internal electron donor.

The method may thus be as hereinbefore described.

According to a fourth aspect of the invention, there is provided a method of making a prepolymerized catalyst suitable for use in a process for producing polymers, which method comprises, broadly, prepolymerizing a catalyst obtained by contacting an activated magnesium chloride with titanium tetrachloride in the presence of a particular internal electron donor.

The method may thus be as hereinbefore described.

According to a fifth aspect of the invention, there is provided a method of making a prepolymerized catalyst suitable for use in a process for producing polymers, which method comprises, broadly, prepolymerizing a metallocene or single site catalyst with propylene and preferably also together with 1-pentene and a further linear or branched olefin in the presence of a co-catalyst.

The invention will now be described in more detail with reference to the following non-limiting examples.

### EXAMPLE 1

### Catalyst A Preparation

In a 500 ml flask equipped with a reflux condenser and stirring facilities, 8 g of partially anhydrized magnesium chloride with a water content of 1.5% were suspended in 150 ml of a mixture comprising, in a 2/1/1 volume ratio, di-pentyl ether/ethanol/propanol. After total salvation, vacuum was applied to the flask and sufficient solvent removed to obtain a syrup. 100 ml of a 10% solution of triethyl aluminium were added dropwise to the flask to avoid excessive heat build up, and the mixture allowed to cool to room temperature under stirring. The slurry was then subjected to ten washings using 150 ml heptane each time.

To the activated support thus formed, was added 2 ml of ethyl benzoate and the resultant mixture stirred for 24 hours. Thereafter 40 ml of TiCl₄ were added and the mixture stirred under reflux. After cooling down, the slurry was subjected to ten washings using 50 ml heptane each time. After the final washing the slurry concentration was adjusted to 0,05 g catalyst/1 ml heptane.

### EXAMPLE 2

### Catalyst B Preparation

In a 500 ml flask equipped with a reflux condenser and stirring facilities, 8 g of anhydrous magnesium chloride were suspended in 150 ml of a mixture comprising, in a 2/1/1 volume ratio, di-butyl ether/propanol/pentanol. After total solvation, vacuum was applied and sufficient solvent removed to obtain a syrup. 100 ml of a 10% solution of triethyl aluminium were added dropwise to the flask to avoid excessive heat build up, and the mixture allowed to cool to room temperature under stirring. The slurry was then subjected to ten washings using 150 ml heptane each time.

To the activated support thus formed, was added 2 ml of ethyl benzoate and the resultant mixture stirred for 24 hours. Thereafter 40 ml of TiCl₄ were added and the mixture stirred under reflux. After cooling down, the slurry was subjected to ten washings using 50 ml heptane each time. After the final washing the slurry concentration was adjusted to 0,05 g catalyst/1 ml heptane.

### EXAMPLE 3

### Catalyst C Preparation

In a 500 ml flask equipped with a reflux condenser and stirring facilities, 8 g of magnesium chloride were suspended in 150 ml of a mixture comprising, in a 2/1/1 volume ratio, di-pentyl ether/propanol/hexanol. After total salvation, vacuum were applied and sufficient solvent removed to obtain a syrup. 100 ml of a 10% solution of triethyl aluminium were added dropwise to the flask to avoid excessive heat build up, and the mixture allowed to cool to room temperature under stirring. The slurry was then subjected to ten washings using 150 ml heptane each time.

To the activated support thus formed, was added 2 ml of ethyl benzoate and the resultant mixture stirred for 24 hours. Thereafter 40 ml of TiCl₄ were added and the mixture stirred under reflux. After cooling down, the slurry was subjected to ten washings using 50 ml heptane each time. After the final washing the slurry concentration was adjusted to 0.05 g catalyst/1 ml heptane.

### EXAMPLE 4

3500 g of highly purified n-heptane were introduced into a 10 l stainless steel polymerization vessel provided with agitation. After a thorough purging of the vessel with nitrogen, 330 ml of a 10% solution of triethyl aluminium were added followed by 5 ml of catalyst A. 0.6 ml of dimethyl diethoxy silane were further added, the temperature set to 70° C. and 20 mg of hydrogen added. After 10 min, a simultaneous constant flow of 20 g/min of propylene and 4 g/min of Fischer-Tropsch derived 1-pentene was started. A ⅕ part of the total ethylene was also introduced each time 100 g of propylene had been introduced into the reaction vessel. A total amount of 500 g of propylene, 100 g of 1-pentene and 15 g of ethylene were introduced and the pressure increased to 10,1 bar. The reaction was continued for another 65 min after the pressure had dropped to a constant 5 bar.

In a next step, the polymerization vessel was depressurized and the catalyst decomposed with propanol. The resultant terpolymer was then filtered and repeatedly washed with propanol, methanol and acetone. The terpolymer was dried in a vacuum oven at 70° C. for 24 hours. The yield of the terpolymer was 550 g.

The melt flow index of the terpolymer was 8.8. The yield strength of the terpolymer was 13,2MPa. The break strength of the terpolymer was 18,4 MPa. The modulus of the terpolymer was 333 MPa. The impact strength of the terpolymer was 42 MPa.

### EXAMPLES 5-11

Example 4 was repeated, except that the amounts of comonomers and hydrogen introduced were varied. The yields obtained are presented in Table 1 and the properties are presented in Table 2.

TABLE 1

| Example | | | | | |
|---|---|---|---|---|---|
| Nr | C3 g | C5 g | C2 g | H2 mg | Yield g |
| 5 | 500 | 150 | 10 | 30 | 500 |
| 6 | 500 | 100 | 5 | 20 | 550 |
| 7 | 500 | 75 | 5 | 20 | 525 |
| 8 | 500 | 40 | 5 | 20 | 525 |
| 9 | 500 | 25 | 10 | 20 | 500 |

TABLE 2

| | | Yield | Break | | |
|---|---|---|---|---|---|
| Example | MFI | Strength | Strength | Modulus | Impact |
| Nr | dg/min. | Mpa | MPa | MPa | kJ/m² |
| 5 | 4,5 | 16,8 | 19,9 | 468 | 27,6 |
| 6 | 6,2 | 19,6 | 22,2 | 489 | 12 |
| 7 | 6,7 | 18,2 | 22,5 | 558 | 8,5 |
| 8 | 8,5 | 23,7 | 23,5 | 751 | 9 |
| 9 | 6,0 | 21,9 | 19,3 | 618 | 7 |
| 10 | 3,1 | 36,4 | 39,5 | 1114 | 3,3 |
| 11 | 5,2 | 31,7 | 20,1 | 846 | 3,5 |

### EXAMPLE 12

3500 g of highly purified n-heptane were introduced into a 10 l stainless steel polymerization vessel provided with agitation. After a thorough purging of the vessel with nitrogen, 330 ml of a 10% solution of triethyl aluminium were added and further 1 g of TiCl₃.⅓ AlCl₃.⅓ n-propyl benzoate. 0,6 ml of diethyl diethoxy silane were further added, the temperature set to 70° C. and 20 mg of hydrogen added. After 10 min, a simultaneous constant flow of 20 g/min of Fischer-Tropsch derived propylene and 4 g/min of Fischer-Tropsch derived 1-pentene was started. 5 g of ethylene were also introduced continuously into the reaction vessel. A total amount of 500 g of propylene, 100 g of 1-pentene and 5 g of ethylene were introduced and the pressure increased to 10,1 bar. The reaction was continued until the pressure had dropped to a constant 5 bar.

In a next step, the polymerization vessel was depressurized and the catalyst decomposed with propanol. The resultant copolymer was then filtered and repeatedly washed with propanol, methanol and acetone. The terpolymer was dried in a vacuum oven at 70° C. for 24 hours. The yield of the terpolymer was 545 g.

The melt flow index of the terpolymer was 7,5. The yield strength of the terpolymer was 18.1 MPa. The break strength of the terpolymer was 18.8 MPa. The modulus of the terpolymer was 442. The impact strength of the terpolymer was 13 MPa.

### EXAMPLE 13

Example 12 was repeated except that 0,6 ml of diphenyl dimethoxy silane were added, and 50 g of 1-pentene and 20 g of ethylene were used. The yield of the terpolymer was 410 g.

The melt flow index of the terpolymer was 11. The yield strength of the terpolymer was 22.5 MPa. The break strength of the terpolymer was 201 MPa. The modulus of the terpolymer was 549 MPa.

### EXAMPLE 14

### Prepolymerization

In a closed glass vessel thoroughly purged with nitrogen, 2,76 mmol of triethyl aluminum were mixed with 29,22 ml of isohexane. After 10 min, 1 g of TiCl₃.⅓AlCl₃.⅓ (n-propyl benzoate) catalyst was added to the vessel to form a catalyst slurry. 0,4 g of Fischer-Tropsch derived 1-pentene were added and further 3 g of propylene were continuously supplied to the catalyst slurry at room temperature under stirring, over a period of 30 min, to produce a prepolymerized catalyst slurry. 10 min after the propylene addition had commenced, an amount of 0,4 g of ethylene was introduced, to produce a prepolymerized catalyst slurry.

### Polymerization

A 1.5 l stainless steel reaction vessel equipped with a helical stirrer was thoroughly purged with nitrogen, and 1.5 mmol triethyl aluminum added thereto. After 10 min stirring, 5 ml of the prepolymerized catalyst slurry were added, and the temperature increased to 67° C. 8.8 mmol of hydrogen were then introduced. 10 ml Fischer-Tropsch derived 1-pentene were introduced through a preheating unit to vaporize it, and simultaneously a propylene flow into the vessel was started. The pressure was increased to 12 bar by means of the propylene, and a continuous supply of propylene was maintained at this constant pressure for 180 min, after which the polymerization was stopped. After the pressure had stabilised, a continuous flow of ethylene was started. A total of 4.2 g of ethylene was introduced. After depressurization and cooling down to room temperature, the reactor was flushed with nitrogen. 154 g of a propylene/1-pentene/ethylene terpolymer were obtained. The 1-pentene content determined by NMR was 0,8% and the ethylene content was 2.4%. The copolymer had a melt flow index of 4.9. The yield strength of the terpolymer was 22.6 MPa, the break strength was 20.4 MPa and the modulus 904 MPa. The impact strength test shows no break.

### EXAMPLE 15

### Prepolymerization

In a closed glass vessel thoroughly purged with nitrogen, 2.76 mmol of triethyl aluminum were mixed with 29,22 ml of iso-hexane. After 10 min, 1 g of TiCl₃.⅓AlCl₃.⅓ (n-propyl benzoate) catalyst was added to the vessel to form a catalyst slurry. 0.8 g of a 1/1 mixture of Fischer-Tropsch derived 1-pentene and Fischer-Tropsch derived 1-hexene were added and further 3 g of propylene were continuously supplied to the catalyst slurry at room temperature under stirring, over a period of 30 min, to produce a prepolymerized catalyst slurry.

### Polymerization

A 1.5-liter stainless steel reaction vessel equipped with a helical stirrer was thoroughly purged with nitrogen, and 2.2 mmol triethyl aluminum added thereto. After 10 min stirring, 5 ml of the prepolymerized catalyst were added, and the temperature increased to 67° C. A mixture of 2.5 ml of 1-hexene and 7,5 ml Fischer-Tropsch derived 1-pentene was introduced through a preheating unit and after pressurising the reactor with propylene to 12 bar, 300 g of propylene were introduced at constant flow over a period of 200 min, where after polymerization was stopped. Twice, after 30 min and 90 min, a mixture of 2.5 ml of Fischer-Tropsch derived 1-hexene and 7.5 ml of 1-pentene was introduced, and finally after 120 min 10 ml of 1-pentene were introduced. After depressurization and cooling down to room temperature, the reactor was flushed with nitrogen. 320 g of a propylene/1-pentene/1-hexene terpolymer were obtained. The 1-pentene content determined by NMR was 4.2% and the 1-hexene content was 1%. The copolymer had a MFI of 1.8. The yield strength was 23.9 MPa, the break strength was 30.6 MPa and the modulus 560 MPa. The impact strength test shows no break.

### EXAMPLE 16

A 1.5-liter stainless steel reaction vessel, equipped with a helical stirrer, was thoroughly purged with nitrogen, and 2.9 mmol triethyl aluminum added thereto. After 10 min stirring, 100 mg of supported catalyst A of Example 1 were added and the temperature increased to 67° C. An amount of 8.84 mmol of hydrogen and 10 ml of di-isopropyl dimethoxy silane were added. The pressure was increased with propylene to 8 bar, and homopolymerization effected for 30 min. 10 ml Fischer-Tropsch derived 1-pentene were further introduced through a preheating unit and after pressurising the reactor with propylene to 12 bar, 300 g of propylene were introduced at constant pressure over a period of 90 min. Simultaneously with the propylene an amount of 15.5 g of ethylene was added. After 30 min of polymerization another 10 ml of Fischer-Tropsch derived 1-pentene were then added. After depressurization and cooling down to room temperature, the reactor was flushed with nitrogen. 350 g of a propylene/1-pentene/ethylene terpolymer were obtained. The 1-pentene content determined by NMR was 1.5% and the ethylene content was 3.9. The copolymer had a MFI of 2.2, the yield strength was 21.50 MPa, the break strength was 20.4 MPa and the modulus 688 MPa. The impact strength test shows no break.

### EXAMPLE 17

### Prepolymerization

In a closed glass vessel thoroughly purged with nitrogen, 3.78 mmol of triethyl aluminum were mixed with 55.39 ml of iso-hexane. After 10 min, 1 g of supported catalyst B was added. 0.3 g of Fischer-Tropsch derived 1-pentene were added, and 3 g of propylene and 0,3 g of ethylene were continuously supplied to the catalyst slurry at room temperature under stirring, over a period of 30 min, to produce a prepolymerized catalyst slurry.

### Polymerization

A 1.5-liter stainless steel reaction vessel equipped with a helical stirrer was thoroughly purged with nitrogen, and 3.4 mmol triethyl aluminum added thereto. After 10 min stirring, 5 ml of the prepolymerized catalyst slurry were added, and the temperature increased to 67° C. 9.52 mmol of hydrogen were introduced, and the pressure was increased to 28 bar with propylene. 21 ml Fischer-Tropsch derived 1-pentene, 12.4 g of ethylene and 270 g propylene were introduced at constant pressure over 3 hours. After depressurization and cooling down to room temperature, the reactor was flushed with nitrogen. 273 g of a propylene/1-pentene/ethylene terpolymer were obtained. The 1-pentene content determined by NMR was 1.9% and the ethylene content was 4%. The copolymer had a MFI of 20. The yield strength was 20.9 MPa, the break strength was 20.4 and the modulus 610 MPa. The impact strength test showed no break.

### EXAMPLE 18

### Prepolymerization

In a closed glass vessel thoroughly purged with nitrogen, 3.78 mmol of triethyl aluminum were mixed with 55.39 ml of iso-hexane. After 10 min, 1 g of catalyst A prepared according to Example 1 was added. 0.3 g of Fischer-Tropsch derived 1-pentene were added, and 3 g of propylene and 0.3 g of ethylene were continuously supplied to the catalyst slurry at room temperature under stirring, over a period of 30 min, to produce a prepolymerized catalyst slurry.

### Polymerization

A 1-liter stainless steel reaction vessel equipped with a helical stirrer was thoroughly purged with nitrogen, and 1.6 ml of a 10% solution of triethyl aluminum in hexane added thereto. After 10 min stirring, 3 ml of prepolymerized catalyst slurry and 0.6 ml of dimethyl diethoxy silane were added and the temperature increased to 70° C. 10 mg of hydrogen were further introduced. A Fischer-Tropsch derived propylene flow of 1.5 g/min was supplied for 70 min. After 30 g of propylene had been supplied, 2.5 g of Fischer-Tropsch derived 1-pentene and 3 g of ethylene were also supplied to the reaction vessel, and the pressure was increased to 28 bar with propylene. After depressurization and cooling down to room temperature, the reactor was flushed with nitrogen. 100 g of a propylene/1-pentene/ethylene terpolymer were obtained. The copolymer had a MFI of 8. The yield strength was 13.7 MPa, the break strength was 18.9 and the modulus 435 MPa. The impact strength was 13.6 MPa.

### EXAMPLE 19

A 1-liter stainless steel reaction vessel equipped with a helical stirrer was thoroughly purged with nitrogen and 1.6 ml of a 10% solution of triethyl aluminum in hexane added thereto. After 10 min stirring, 3 ml of the prepolymerized catalyst slurry obtained in Example 14 and 0.6 ml of dimethyl diethoxy silane were added and the temperature increased to 70° C. 10 mg of hydrogen were further introduced. Thereafter, a propylene flow of 1.5 g/min was supplied for 70 min. After 20 g of propylene had been supplied, 10 g of Fischer-Tropsch derived 1-pentene were added. After 40 min of Fischer-Tropsch derived propylene supply, 3 g of ethylene were also supplied to the reaction vessel. After depressurization and cooling down to room temperature, the reactor was flushed with nitrogen. 100 g of a propylene/1-pentene/ethylene terpolymer were obtained. The copolymer had a MFI of 7. The yield strength was 11.6 MPa, the break strength was 11.3 and the modulus 251 MPa. The impact strength was 24 MPa.

### EXAMPLE 20

### Preparation of a Polymer Diluted Catalyst

In a 250 ml flask, 4 g of catalyst A of Example 1 were reacted under nitrogen with 40 ml solution of triethyl aluminium in heptane. After 5 min, 40 g of a terpolymer powder obtained according to Example 4 were added and thoroughly mixed. The mixture was vacuum dried to obtain a polymer diluted catalyst.

### EXAMPLE 21

A 1-liter stainless steel reaction vessel equipped with a helical stirrer was thoroughly purged with nitrogen and 1.6 ml of a 10% solution of triethyl aluminum in hexane added thereto. After 10 min stirring, 5 g of polymer diluted catalyst obtained according to Example 20 and 0.6 ml of dimethyl diethoxy silane were added, and the temperature increased to 70° C. 10 mg of hydrogen were further introduced. Thereafter, a propylene flow of 1.5 g/min was supplied for 70 min. After 25 g of propylene had been supplied, 25 g of Fischer-Tropsch derived 1-pentene and 2 g of ethylene were introduced. After 40 min of propylene supply, another 2 g of ethylene were supplied to the reaction vessel. After depressurization and cooling down to room temperature, the reactor was flushed with nitrogen. 85 g of a propylene/1-pentene/ethylene terpolymer were obtained. The terpolymer had a MFI of 7. The yield strength was 9.44 MPa, the break strength was 13.2 and the modulus 275 MPa. The impact strength was 30.2 MPa.

### EXAMPLE 22

Example 21 was repeated, except that after 20 minutes of propylene supply, 10 g Fischer-Tropsch derived 1-pentene and 5 g of ethylene were introduced. 83 g of terpolymer were obtained. The terpolymer had a melt flow index of 8, a yield strength of 7.9 MPa, a break strength of 7.4 MPa, a modulus of 215 MPa and an impact of 20.0. MPa.

### EXAMPLE 23

Example 21 was repeated, except that after 20 minutes of propylene supply, 5 g Fischer-Tropsch derived 1-pentene and 1.7 g of ethylene were introduced together with 20 mg of hydrogen. 78 g of terpolymer were obtained. The terpolymer has a melt flow index of 28, a yield strength of 15.3 MPa, a break strength of 11.7 MPa, a modulus of 374 MPa and an impact of 14.8 MPa.

### EXAMPLE 24

A 1-liter stainless steel reaction vessel equipped with a helical stirrer was thoroughly purged with nitrogen and 1.6 ml of a 10% solution of triethyl aluminum in hexane added thereto. After 10 min stirring, 0.3 g of supported catalyst C of Example 3 and 0.6 ml of dimethyl diethoxy silane were added, and the temperature increased to 70° C. 10 mg of hydrogen were further introduced. Thereafter, a propylene flow of 1,5 g/min was supplied for 70 min, simultaneously with a flow of 10 g Fischer-Tropsch derived 1-pentene and 5 g of ethylene to the reaction vessel. After depressurization and cooling down to room temperature, the reactor was flushed with nitrogen. 100 g of a propylene/1-pentene/ethylene terpolymer were obtained. The copolymer had a MFI of 7. The yield strength was 12.10. MPa, the break strength was 20,3 and the modulus 268 MPa. The impact strength test showed no break.

### EXAMPLE 25

A 1-liter stainless steel reaction vessel equipped with a helical stirrer was thoroughly purged with nitrogen and 1.6 ml of a 10% solution of triethyl aluminum in hexane added thereto. After 10 min stirring, 0.5 g of catalyst B of Example 2 and 0.6 ml of dimethyl diethoxy silane were added and the temperature increased to 70° C. 20 mg of hydrogen were further introduced. Thereafter, a propylene flow of 1.5 g/min was supplied for 70 min, simultaneously with a flow of 5 g Fischer-Tropsch derived 1-pentene and 5 g of 1-butene to the reaction vessel. After depressurisation and cooling down to room temperature, the reactor was flushed with nitrogen. 95 g of a propylene/1-pentene/1-butene terpolymer were obtained. The copolymer had a MFI of 36. The yield strength was 9.6 MPa, the break strength was 16.8 and the modulus 239 MPa. The impact strength test showed no break.

### EXAMPLE 26

To a 1-liter stainless steel automated autoclave fitted with heating, cooling and stirring facilities, and thoroughly purged with nitrogen, was added 380 g polymerization grade heptane and the temperature set at 20° C. To this was added 7.8 ml of a 10% solution of MAO in toluene containing 1.5 mg of bis (2-methyl benzindenyl)dimethyl silyl zirconium dichloride, 50 ml 1-pentene and 50 ml 1-hexene. Subsequently, 100 g propylene were introduced at a flow rates of 10 g/min. After 90 minutes the reaction was terminated by addition of 200 ml acetone. The product was filtered, repeatedly washed with acetone and subsequently dried at 80° C.

The amount of comonomer incorporated was determined via ¹³C-NMR spectroscopy by comparison of the branched versus all of the backbone carbons. The amount of 1-pentene and 1-hexene incorporated was determined to be 14.1 mol-%.

Rheological determinations were done according to description. The dynamic zero shear viscosity η at 190° was 52952 Pa s. The Carreau-Gahleitner equation parameters a, b, and p were 0.0002802, 0.16065 and 9.2533, respectively at 190°.

The number averaged molecular weight Mₙ was determined to be 157000 g/mol by size exclusion chromatography with reference to a polystyrene standard.

### EXAMPLE 27

To a 1-liter stainless steel automated autoclave fitted with heating, cooling and stirring facilities, and thoroughly purged with nitrogen, was added 380 g polymerization grade heptane and the temperature set at 20° C. To this was added 10 ml of a 10% solution of MAO in toluene containing 2 mg of bis(2-methyl benzindenyl)dimethyl silyl zirconium dichloride and 50 g 1-pentene. Subsequently, 100 g propylene and 10 g ethylene were introduced at flow rates of 10 g/min. After 90 minutes the reaction was terminated by addition of 200 ml acetone. The product was filtered, repeatedly washed with acetone and subsequently dried at 80° C.

The amount of 1-pentene incorporated was determined via ¹³C-NMR spectroscopy by comparison of the branched versus all of the backbone carbons. The amount of 1-pentene incorporated was determined to be 11.9 mol-%.

Rheological determinations of the dynamic zero shear viscosity η at 190° yielded 206.05 Pa s. The Carreau-Gahleitner equation parameters a, b, and p were 0.0004952, 0.28923, 1.9108000 respectively at 190°. The number averaged molecular weight Mₙ was determined to be 69000 g/mol by size exclusion chromatography with reference to a polystyrene standard.

### EXAMPLE 28

To a 1-liter stainless steel automated autoclave fitted with heating, cooling and stirring facilities, and thoroughly purged with nitrogen, was added 380 g polymerization grade heptane and the temperature set at 20° C. To this was added 7.8 ml of a 10% solution of MAO in toluene containing 1.5 mg of bis(2-methyl benzindenyl)dimethyl silyl zirconium dichloride and 124.8 ml 1-pentene. Subsequently, 100 g propylene and 10 g ethylene were introduced at flow rates of 10 g/min. After 60 minutes the reaction was terminated by addition of 200 ml acetone. The product was filtered, repeatedly washed with acetone and subsequently dried at 80° C. The obtained product yield was 72.3 g.

The amount of 1-pentene incorporated was determined via ¹³C-NMR spectroscopy by comparison of the branched versus all of the backbone carbons. The amount of 1-pentene incorporated was determined to be 20.1 mol-%.

Rheological determinations of the dynamic zero shear viscosity η at 190° yielded 305.33 Pa s. The Carreau-Gahleitner equation parameters a, b, and p were 167.73, 8.1111, 0.0134790 respectively at 190°. The number averaged molecular weight Mₙ was determined to be 71000 g/mol by size exclusion chromatography with reference to a polystyrene standard.

### EXAMPLE 29

To a 1-liter stainless steel automated autoclave fitted with heating, cooling and stirring facilities, and thoroughly purged with nitrogen, was added 380 g polymerization grade heptane and the temperature set at 20° C. To this was added 8 ml of a 10% solution of MAO in toluene containing 1.5 mg of bis(2-methyl benzindenyl)dimethyl silyl zirconium dichloride, 40 ml 1-pentene and 40 ml 1-octene. Subsequently, 100 g propylene were introduced at a flow rates of 15 g/min. After 90 minutes the reaction was terminated by addition of 200 ml acetone. The product was filtered, repeatedly washed with acetone and subsequently dried at 80° C.

The amount of comonomer incorporated was determined via ¹³C-NMR spectroscopy by comparison of the branched versus all of the backbone carbons. The amount of 1-pentene and 1-octene incorporated was determined to be 13.2 mol-%.

Rheological determinations of the dynamic zero shear viscosity η at 190° yielded 2885100 Pa s. The Carreau-Gahleitner equation parameters a, b, and p were 94.908, 8.1111 and 0.0943230 respectively at 190°. The number averaged molecular weight Mₙ was determined to be 164000 g/mol by size exclusion chromatography with reference to a polystyrene standard.

### EXAMPLE 30

A 1-liter stainless steel reaction vessel equipped with a stirrer was thoroughly purged with nitrogen and 8 ml of a 10% solution of triethyl aluminum in hexane added thereto. After 10 min stirring, 0.2 g of a magnesium chloride supported titanium catalyst and 2 ml of dimethyl diethoxy silane were added, and the temperature increased to 80° C. 20 mg of hydrogen were further introduced. Thereafter, 40 ml Fischer-Tropsch derived 1-pentene, 40 ml 4-methyl-1-pentene and 100 g propylene added and the mixture stirred for 80 minutes. After depressurization and cooling down to room temperature, the reactor was flushed with nitrogen. 96 g of a polymer was obtained. The amount of comonomer incorporated was determined via ¹³C-NMR spectroscopy by comparison of the branched versus all of the backbone carbons. The amount of 1-pentene and 4-methyl-1-pentene incorporated was determined to be 8.3 mol-%.

### EXAMPLE 31

To a 1-liter stainless steel automated autoclave fitted with heating, cooling and stirring facilities, and thoroughly purged with nitrogen, was added 350 g polymerization grade heptane and the temperature set at 40° C. To this was added 8 ml of a 10% solution of MAO in toluene containing 1.5 mg of bis(2-methyl benzindenyl)dimethyl silyl zirconium dichloride. Subsequently, 40 ml 1-pentene, 40 ml 4-methyl-1-pentene and 100 g propylene were introduced at a flow rates of 9 g/min. After 90 minutes the reaction was terminated by addition of 200 ml acetone. The product was filtered, repeatedly washed with acetone and subsequently dried at 80° C.

The amount of comonomer incorporated was determined via ¹³C-NMR spectroscopy by comparison of the branched versus all of the backbone carbons. The amount of 1-pentene and 4-methyl-1-pentene incorporated was determined to be 7.44 mol-%.

### EXAMPLE 32

A 1-liter stainless steel reaction vessel equipped with a stirrer was thoroughly purged with nitrogen and 8 ml of a 10% solution of triethyl aluminum in hexane added thereto. After 10 min stirring, 0.2 g of a magnesium chloride supported titanium catalyst and 2 ml of dimethyl diethoxy silane were added, and the temperature increased to 80° C. 20 mg of hydrogen were further introduced. Thereafter, 40 ml Fischer-Tropsch derived 1-pentene, 40 ml 3 methyl-1-butene and 100 g propylene added and the stirred for 60 minutes. After depressurization and cooling down to room temperature, the reactor was flushed with nitrogen. The terpolymer had a MFI of 32.01. The amount of 1-pentene incorporated was determined to be 5.6 mol-% with regard to propene. The amount of 3-methyl-1-butene incorporated was determined to be below 1 mol-% with regard to propene.

### EXAMPLE 33

To a 1-liter stainless steel automated autoclave fitted with heating, cooling and stirring facilities, and thoroughly purged with nitrogen, was added 350 g polymerization grade heptane and the temperature set at 40° C. To this was added 8 ml of a 10% solution of MAO in toluene containing 1.5 mg of bis(2-methyl benzindenyl)dimethyl silyl zirconium dichloride. Subsequently, 100 g propylene, 40 ml 1-pentene and 40 ml 3-methyl-1-butene were introduced. After 90 minutes the reaction was terminated by addition of 200 ml acetone. The product was filtered, repeatedly washed with acetone and subsequently dried at 80° C. The amount of comonomer incorporated was determined via ¹³C-NMR spectroscopy by comparison of the branched versus all of the backbone carbons. The amount of 1-pentene incorporated was determined to be 8.6 mol-% with regard to propene. The amount of 3-methyl-1-butene incorporated was determined to be below 1 mol-% with regard to propene.

1. A polymer which includes at least propylene as a first monomeric component, 1-pentene as a second monomeric component, and, as a third monomeric component, a third olefin, wherein the third olefin has fewer than 5 carbon atoms, is linear and is not propylene, or has 5 carbon atoms and is branched, or has more than 5 carbon atoms and is linear or branched.

2. A polymer according to claim 1, wherein at least one of the monomeric components is Fischer-Tropsch derived so that it includes at least one other olefinic component.

3. A polymer according to claim 2, wherein a plurality of other olefinic components are present in the Fischer-Tropsch derived monomeric component, with the mass proportion of other olefinic components in the Fischer-Tropsch derived monomeric component being from 0.002% to 2%.

4. A polymer according to claim 3, wherein the second monomeric component and/or the third monomeric component is Fischer-Tropsch derived.

5. A polymer according to claim 1, wherein the ratio of the molar proportion of propylene to that of the sum of the molar proportions of 1-pentene and the third monomeric component is between 99.9:0.1 and 50:50.

6. A polymer according to claim 1, wherein the ratio of the molar proportion of 1-pentene to that of the third monomeric component is between 0.01:99.99 and 99.99:0.01.

7. A polymer according to claim 1, wherein the third olefin has fewer than 5 carbon atoms and its reactivity is greater than that of 1-pentene.

8. A polymer according to claim 1, wherein the third olefin has fewer than 5 carbon atoms and is ethylene or 1-butene.

9. A polymer according to claim 1, wherein the third olefin has 5 carbon atoms and is branched, and is 3-methyl-1-butene.

10. A polymer according to claim 1, wherein the third olefin has more than 5 carbon atoms and is linear or branched, and has a reactivity which is lower than that of 1-pentene.

11. A polymer according to claim 1, wherein the third olefin has more than 5 carbon atoms and is branched, and is 3-methyl-1-pentene or 4-methyl-1-pentene.

12. A polymer according to claim 1, wherein the third olefin has more than 5 carbon atoms and is linear, and is 1-hexene, 1-heptene, 1-octene, or 1-nonene.

13. A polymer according to claim 4, wherein the second monomeric component is Fischer-Tropsch derived, with the other olefinic components constituting about 0.5% of the second monomeric component and comprising
2-methyl-1-butene; and/or
branched olefins having a carbon number of 5; and/or
internal olefins having a carbon number of 5; and/or
cyclic olefins having a carbon number of 5.

14. A polymer according to claim 4, wherein the third monomeric component is Fischer-Tropsch derived; and
wherein the third olefin is 1-hexene, with the other olefinic components present in the third monomeric component comprising
branched olefins having a carbon number of 6; and/or
internal olefins having a carbon number of 6; and/or
cyclic olefins having a carbon number of 6;
or
wherein the third olefin is 1-heptene, with the other olefin components present in the third monomeric component comprising
branched olefins having a carbon number of 7; and/or
internal olefins having a carbon number of 7;
or
wherein the third olefin is 1-octene, with the other olefin components present in the third monomeric component comprising
branched olefins having a carbon number of 8; and/or
internal olefins having a carbon number of 8;
or
wherein the third olefin is 1-nonene, with the other olefinic components present in the third monomeric component comprising
branched olefins having a carbon number of 9; and/or
internal olefins having a carbon number of 9.

15. A polymer according to claim 1, which is that obtained by reacting at least the propylene, the 1-pentene and the third olefin in one or more reaction zones, while maintaining the reaction zone(s) at a pressure between atmospheric pressure and 200 kg/cm², and at a temperature between ambient and 120° C., in the presence of a catalyst, or a catalyst system comprising a catalyst and a cocatalyst.

16. A process for producing a polymer, which comprises reacting at least a first monomeric component comprising propylene, a second monomeric component comprising 1-pentene, and a third monomeric component comprising a third olefin which has fewer than 5 carbon atoms, is linear and is not propylene, or has 5 carbon atoms and is branched, or has more than 5 carbon atoms and is linear or branched, in one or more reaction zones, while maintaining the reaction zone(s) at a pressure between atmospheric pressure and 200 kg/cm², and at a temperature between ambient and 120° C., in the presence of a catalyst, or a catalyst system comprising a catalyst and a cocatalyst.

17. A process according to claim 16, wherein the reaction is effected in continuous fashion, with the reaction zone(s) being provided in a single stage reactor vessel or in a chain of two or more reactor vessels.

18. A process according to claim 1 7, wherein all the comonomers are introduced continuously into the reaction zone(s) at constant flow and/or at constant pressure.

19. A process according to claim 17, wherein the propylene is introduced continuously into the reaction zone(s), while the second and third monomeric components are introduced separately and continuously.

20. A process according to claim 17, wherein the propylene is introduced continuously into the reaction zone(s), while the second and third monomeric components are introduced separately and discontinuously.

21. A process according to claim 17, wherein the propylene is introduced continuously into the reaction zone(s), while the second and third monomeric components are introduced simultaneously and discontinuously.

22. A process according to claim 17, wherein the propylene is introduced discontinuously into the reaction zone(s), while the second and third monomeric components are introduced separately and continuously.

23. A process according to claim 17, wherein the propylene is introduced discontinuously into the reaction zone(s), while the second and third monomeric components are introduced simultaneously and continuously.

24. A process according to claim 17, wherein the propylene is introduced discontinuously into the reaction zone(s), while the second and third monomeric components are introduced simultaneously and discontinuously.

25. A process according to claim 16, wherein the reaction is effected in batch fashion, with the reaction zone(s) being provided in a single stage reactor vessel or in a chain of two or more reactor vessels.

26. A process according to claim 25, wherein all the monomeric components are introduced continuously into the reaction zone(s) at constant flow and/or at constant pressure.

27. A process according to claim 25, wherein the propylene is introduced continuously into the reaction zone(s), while the second and third monomeric components are introduced separately and continuously.

28. A process according to claim 25, wherein the propylene is introduced continuously into the reaction zone(s), while the second and third monomeric components are introduced separately and discontinuously.

29. A process according to claim 25, wherein the propylene is introduced continuously into the reaction zone(s), while the second and third monomeric components are introduced simultaneously and discontinuously.

30. A process according to claim 25, wherein the propylene is introduced discontinuously into the reaction zone(s), while the second and third monomeric components are introduced separately and continuously.

31. A process according to claim 25, wherein the propylene is introduced discontinuously into the reaction zone(s), while the second and third monomeric components are introduced simultaneously and continuously.

32. A process according to claim 25, wherein the propylene is introduced discontinuously into the reaction zone(s), while the second and third monomeric components are introduced simultaneously and discontinuously.

33. A process according to claim 16, wherein the reaction is conducted in slurry phase.

34. A process according to claim 16, wherein the reaction is conducted in vapour phase.

35. A process according to claim 34, wherein the catalyst is a prepolymerized catalyst.

36. A process according to claim 34, wherein the catalyst has been prepolymerized in the presence of propylene, 1-pentene and a third olefin which has fewer than 5 carbon atoms, is linear and is not propylene, or has 5 carbon atoms and is branched, or has more than 5 carbon atoms and is linear or branched.

37. A process according to claim 34, wherein the catalyst is a polymer diluted catalyst.

38. A process according to claim 34, wherein the catalyst is a polymer diluted catalyst obtained by mixing it with a terpolymer of propylene, 1-pentene and a third olefin which has fewer than 5 carbon atoms, is linear and is not propylene, or has 5 carbon atoms and is branched, or has more than 5 carbon atoms and is linear or branched.

39. A process according to claim 16, wherein the reaction is conducted in solution phase.

40. A process according to claim 16, wherein a Ziegler-Natta catalyst or a catalyst system comprising a Ziegler-Natta catalyst and a cocatalyst is used.

41. A process according to claim 40, wherein the Ziegler-Natta catalyst is that obtained by
i) suspending partially anhydrous magnesium chloride containing between 2 and 6 moles of water in a highly purified hydrocarbon solvent to obtain a magnesium chloride slurry;
ii) adding to the slurry a mixture of alcohols and an ether with the alcohol:ether molar ratio being between 1:1 and 1:6, and stirring the mixture for a period of time between 10 minutes and 20 hours, to obtain a partially activated magnesium chloride;
iii) filtering and washing the partially activated magnesium chloride slurry with a highly purified hydrocarbon solvent until no ether is detected in the washing liquid, to obtain a washed partially activated magnesium chloride;
iv) adding thereto, in drop wise fashion, an alkyl aluminium compound with the molar ratio between the alkyl aluminum and the magnesium chloride between 1:1 and 1:6, followed by grinding to a smooth consistency and cooling to room temperature, to obtain an activated magnesium chloride;
v) washing the activated magnesium chloride with a highly purified hydrocarbon solvent until no alkyl aluminium is detected in the washing liquid, to obtain a washed activated magnesium chloride, which constitutes the support of the catalyst;
vi) adding an internal electron donor selected from the group of organic esters with the molar ratio between the ester and the magnesium chloride between 1:1 and 1:50;
vii) adding titanium tetrachloride to the resulting modified support, and grinding it to a smooth consistency to obtain a titanium loaded catalyst; and
viii) washing the titanium loaded catalyst with a highly purified hydrocarbon solvent until no titanium is detected in the washing liquid, to obtain the catalyst.

42. A process according to claim 16, wherein a metallocene catalyst or a single site catalyst, or a catalyst system comprising a metallocene or single site catalyst and a cocatalyst, is used.

43. A process according to claim 42, wherein the catalyst has the general formula ZL(AR)₂MX₂, where Z is H, Me (methyl), Et (ethyl), Pr (propyl), i-Pr, Bu (butyl), i-Bu, or benzyl; L is a Z-substituted bridging group selected from Si, Ge, or Et (ethyl); A is cyclopentadienyl, indenyl, or fluorenyl; R is H, Me (methyl), Et (ethyl), Pr (propyl), i-Pr, Bu (butyl), i-Bu, or benzyl; M is titanium, zirconium or hafnium; and X is Cl or CH₃.
